(19) United States
(12) Patent Application Publication
(10) Pub. No.: US 2023/0390966 A1
(43) Pub. Date: Dec. 7, 2023

(54) SYSTEMS AND METHODS FOR PRODUCTION OF MATERIALS USED IN ADDITIVE MANUFACTURING

(71) Applicant: Applied Cavitation, Inc., Goleta, CA (US)

(72) Inventors: Dana Lynn HANKEY, Santa Barbara, CA (US); Joseph Albert CAPOBIANCO, Marlton, NJ (US); Marshall Campion TIBBETTS, Goleta, CA (US); Michael Alan MASTROPIETRO, Santa Barbara, CA (US); Andrew John BAMBACH, Goleta, CA (US); Enrique Sarria MORIN, Goleta, CA (US)

(73) Assignee: Applied Cavitation, Inc., Goleta, CA (US)

(21) Appl. No.: 18/248,922

(22) PCT Filed: Oct. 14, 2021
(86) PCT No.: PCT/US2021/055087

§ 371 Date: Apr. 13, 2023

Related U.S. Application Data
(60) Provisional application No. 63/092,098, filed on Oct. 15, 2020.

(51) Int. Cl. B29B 7/82; B29B 7/90; B33Y 70/10; B33Y 40/10

(52) U.S. Cl. CPC B29B 7/826; B29B 7/823; B29B 7/90; B33Y 70/10; B33Y 40/10

(57) ABSTRACT

In one aspect, the present disclosure is directed to a method of manufacturing a substance having an improved tensile strength for additive manufacturing. The method can include providing raw material having a first tensile strength. The raw material can include a polymer. The method can include providing a filler material. The filler material can include clay, single wall carbon nanotubes, multi-wall carbon nanotubes, or boron nitride. The method can include cavitating, within a hydrodynamic cavitation chamber, the raw material and the filler material to produce a substance having a second tensile strength greater than the first tensile strength.

### RELATED APPLICATIONS

This application claims priority to U.S. Patent Provisional Patent Application No. 63/092,098, titled “SYSTEMS AND METHODS FOR PRODUCTION OF MATERIALS USEFUL IN ADDITIVE MANUFACTURING” filed on Oct. 15, 2020, the contents of all of which are incorporated herein.

### BACKGROUND

Additive manufacturing, sometimes referred to a three-dimensional printing, techniques allow for the creation of parts having improved performance, complex geometries and simplified fabrication by the precise deposition of material, layer upon layer. However, materials used in additive manufacturing can be brittle and easily break.

### SUMMARY

The systems, methods, and devices of this disclosure each have several innovative aspects, no single one of which is solely responsible for the desirable attributes disclosed herein.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

In one aspect, the present disclosure is directed to a method of manufacturing a substance having an improved tensile strength for additive manufacturing. The method can include providing raw material having a first tensile strength. The method can include providing a filler material. The method can include cavitating, within a hydrodynamic cavitation chamber, the raw material and the filler material to produce a substance having a second tensile strength greater than the first tensile strength.

In some implementations, the method can include heating the raw material and the filler material to a temperature between 80° C. and 200° C.

In some implementations, the method can include applying ultraviolet (UV) light energy to the substance to cure the substance.

In some implementations, the method can include forcing, the raw material and the filler material into an orifice of the hydrodynamic cavitation chamber.

In some implementations, providing the filler material comprises providing a clay comprising Halloysite, Cloisite, Laponite, or Hubnerite.

In some implementations, providing the filler material comprises providing a single wall carbon nanotube that comprises 0.25 to 10.00% weight for weight (w/w) of the raw material.

In some implementations, providing the filler material comprises providing a multi-walled carbon nanotube that comprises 0.25 to 10.00% w/w of the raw material.

In some implementations, providing the filler material comprises providing a purified single wall carbon nanotube that comprises 0.25 to 10.00% w/w of the raw material.

In some implementations, providing the raw material comprises providing the raw material comprising an ethylene-propylene copolymer.

In some implementations, providing the raw material comprises providing the raw material comprising a solvent. In some implementations, the method can include applying heat to the substance to remove the solvent.

In another aspect, the present disclosure is directed to a substance useful in additive manufacturing produced by the method of claim 1.

In yet another aspect, the present disclosure is directed to a substance useful in additive manufacturing having an improved tensile strength. The substance can include a raw material including a polymer, the raw material having a first tensile strength. The substance can include a clay entangled in the raw material to produce the substance having a second tensile strength greater than the first tensile strength.

In some implementations, the raw material is an ethylene-propylene copolymer.

In some implementations, the clay comprises Halloysite, Cloisite, Laponite, or Hubnerite.

In yet another aspect, the present disclosure is directed to a substance that is useful in additive manufacturing having an improved tensile strength. The substance can include a raw material including a polymer, the raw material having a first tensile strength. The substance can include a carbon material entangled in the raw material to produce the substance having a second tensile strength greater than the first tensile strength.

In some implementations, the carbon material is a single wall carbon nanotube that comprises 0.01 to 10.00% w/w of the raw material.

In some implementations, the carbon material is a multi-walled carbon nanotube that comprises 0.01 to 10.00% w/w of the raw material.

In yet another aspect, the present disclosure is directed to a substance that is useful in additive manufacturing having an improved tensile strength. The substance can include a raw material including a polymer, the raw material having a first tensile strength. The substance can include Boron Nitride entangled in the raw material to produce the substance having a second tensile strength greater than the first tensile strength.

In some implementations, the Boron Nitride comprises 0.01 to 75.00% w/w of the raw material.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 provides a schematic of an example cavitation or emulsifying machine, according to an illustrative implementation.

FIG. 2 provides a schematic of another example cavitation or emulsifying machine further including a thermal control system and a closed system that facilitates multiple cavitation passes, according to an illustrative implementation.

FIG. 3 provides a flowchart illustrating a cavitation process to produce a substance having improved tensile strength, according to an illustrative implementation.

FIGS. 4A and 4B depict graphs of experimental data corresponding to tensile strength of Trilene 65 mixed, at various proportions, with high aspect ratio fillers.

FIG. 5A depicts the tensile strength of Trilene 65 based on various proportions of single wall carbon nanotubes (SWCNT).

FIG. 5B depicts the durometer of Trilene 65 based on various proportions of SWCNT.

FIG. 5C depicts the durometer and pull force of Trilene 65 mixed with various proportions of SWCNT.

FIG. 6A depicts the tensile strength of Trilene 65 based on various proportions of Boron Nitride (PT-132).

FIG. 6B depicts the durometer of Trilene 65 based on various proportions of Boron Nitride (PT-132).

FIG. 6C depicts the durometer and pull force of Trilene 65 mixed with various proportions of Boron Nitride (PT-132).

FIG. 7A depicts the tensile strength of Trilene 65 based on various proportions of Boron Nitride (BTBN5006).

FIG. 7B depicts the durometer of Trilene 65 based on various proportions of Boron Nitride (BTBN5006).

FIG. 7C depicts the durometer and pull force of Trilene 65 mixed with various proportions of Boron Nitride (BTBN5006).

FIG. 8A depicts the tensile strength of Trilene 65 based on various proportions of Boron Nitride (BTBN5003).

FIG. 8B depicts the durometer of Trilene 65 based on various proportions of Boron Nitride (BTBN5003).

FIG. 8C depicts the durometer and pull force of Trilene 65 mixed with various proportions of Boron Nitride (BTBN5003).

FIGS. 9A-9C illustrate the steps of forming a sintered product from a raw material, according to an illustrative implementation.

FIG. 10 provides a flowchart illustrating an additive manufacturing process, according to an illustrative implementation.

FIG. 11 provides a microscopy image of a cross section showing platinum co-fired on zirconia, according to an illustrative implementation.

FIG. 12 provides a microscopy image of a cross section showing nano alumina, according to an illustrative implementation.

### DETAILED DESCRIPTION

Following below are more detailed descriptions of various concepts related to, and implementations of, systems and methods for the production of materials useful for additive manufacturing that include functional fillers, such as ceramic materials, cellulose fibers, single-walled carbon nanotubes, multi-walled carbon nanotubes, boron nitride, and hallosysite. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Cavitation

Cavitation may refer to the formation of vapor cavities in a liquid (e.g., small liquid-free zones such as “bubbles” or “voids”) that result from forces acting on the liquid. The process generally may occur by subjecting a liquid to rapid changes of pressure that cause the formation of cavities where the pressure is relatively low. When subjected to higher pressure, the voids may implode and may generate an intense shockwave. Depending on the application, any suitable mode of cavitation can be employed in the methods and systems provided herein. For example, the cavitation process in one implementation may involve, or be, hydrodynamic cavitation.

Hydrodynamic cavitation refers to a process of vaporization, bubble generation, and bubble implosion, which occurs in a flowing liquid as a result of a decrease and subsequent increase in pressure. Hydrodynamic cavitation may be produced by passing a liquid through a constricted channel at a specific velocity or by mechanical rotation of an object through a liquid. In the case of the constricted channel and based on the specific (or unique) geometry of the system, the combination of pressure and kinetic energy may create the hydrodynamic cavitation cavern downstream of the local constriction generating high energy cavitation bubbles.

Orifices and venturi tubes may be used for generating cavitation. A venturi tube may be employed because of its smooth converging and diverging sections, such that that it may generate a higher velocity at the throat for a given pressure drop across it. On the other hand, an orifice may accommodate more numbers of holes (larger perimeter of holes) in a given cross sectional area of the pipe. Both options are possible.

Some of the pre-existing cavitation systems utilize opposing water jets to create the pressure needed for cavitation to occur while others create the pressure and resulting vacuum by having hydraulic pumps driving and oscillating plungers that draw the low viscosity materials in and then pushes the low viscosity material through the specific point where cavitation occurs. However, none of these pre-existing systems is equipped to handle a raw material that has a viscosity higher than that of a fluid, to disperse the constituents, or to attain the desired particle size distribution through de-agglomeration.

Additive Manufacturing

Additive manufacturing, sometimes referred to as three-dimensional (3D) printing, is a process for constructing three-dimensional solid objects from a digital model. The process is considered additive manufacturing because the product is constructed through successive layer depositions to its final shape, as contrasted with subtractive processes such as traditional machining, cutting, drilling, and grinding. Generally, additive manufacturing is subdivided into three techniques: stereolithography, fused filament fabrication, and selective laser sintering. Each of these techniques can make use of a different type of raw material.

Stereolithography is an additive manufacturing process that employs a liquid raw material to produce a product. Specifically, a vat of liquid, ultraviolet-curable, photopolymer resin and an ultraviolet laser are used to build sequential layers of the product. For each layer, the laser beam traces a cross-section of the part pattern on the surface of the liquid resin. Exposure to the ultraviolet laser light cures and solidifies the pattern traced on the resin and joins it to the layer below. The first layer can be supported on an elevator platform within the vat of liquid.

After the pattern has been traced, the elevator platform descends by a distance equal to the thickness of a single layer, which can be in the range of about 0.05 millimeters to 0.15 millimeters. Then, a resin-filled blade can sweep across the cross-section of the part to coat it with fresh material. On this new liquid surface, the subsequent layer pattern is traced by the laser, thereby joining the layer to the previous layer. These steps can be repeated until the complete product is formed.

In fused filament fabrication, the product or part is produced by extruding small beads of thermoplastic polymers (or thermoplastic polymer composites) from a nozzle. A filament of raw material is unwound from a coil and supplies the raw material to an extrusion nozzle at a controlled rate. The nozzle can be heated to soften the raw material of the filament as it is extruded. The nozzle can be moved in both horizontal and vertical directions by a numerically-controlled mechanism. The nozzle follows a tool-path controlled by a computer-aided manufacturing software package, and the part is built from the bottom up, one layer at a time.

Selective laser sintering works similarly to stereolithography, with key distinct differences. First, instead of liquid photopolymer in a vat, the raw material used for selective laser sintering is a bed layer containing powdered materials, such as polystyrene, ceramics, glass, nylon, and metals including steel, titanium, aluminum, and silver. The bed preheats the powders to a specified temperature while a high power laser is rastered across the surface to selectively fuse small particles of plastic, metal, ceramic, or glass powders into a desired three-dimensional shape. The laser selectively fuses powdered material by scanning cross-sections generated from a 3-D digital description of the part (for example from a CAD file or scan data) on the surface of a powder bed. After each cross-section is scanned, the powder bed is lowered by a distance equal to the thickness of one layer, a new layer of raw material is applied on top, and the process is repeated until the part is completed. When the laser hits the powder, the powder is fused at that point, for example by sintering. All unsintered powder remains as is, and can become a support structure for the object.

The raw materials (i.e., inks, pastes, filaments, etc.) can be improved by effectively breaking up agglomerates to reduce the average particle size of the raw material. Furthermore, effectively dispersing functional filler materials within the raw materials can result in more uniform substances having improved tensile strength. As described below, a hydrodynamic cavitation process can be used to produce raw materials for additive manufacturing having small average particle sizes and improved dispersion of functional fillers in the raw material.

Cavitation Equipment

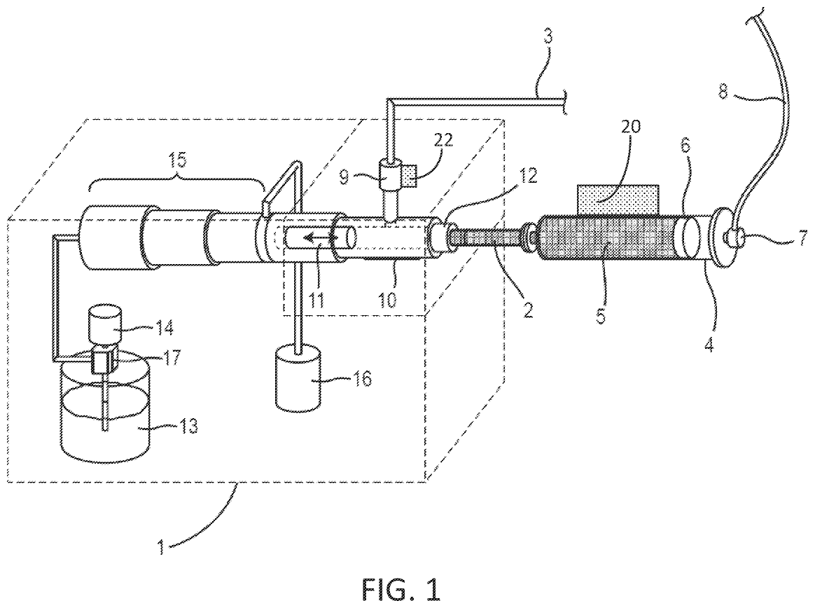

Depending on the application, any suitable equipment capable of carrying out a cavitation or an emulsifying process may be employed to produce materials for additive manufacturing. FIG. 1 depicts a schematic of a cavitation or emulsifying machine 1, according to an illustrative implementation. The machine comprises an inlet 2 and an outlet 3. The machine 1 may be a commercially-available cavitation machine or may be a custom-designed cavitation machine. For example, in some implementations, the cavitation machine 1 may be a homogenizer or a microfluidizer.

Referring now to FIG. 1, one embodiment of a machine 1 is shown connected to a feed tube 4 and a piston 6 that pushes raw material 5 down the feed tube 4, forcing it into the inlet 2 of the machine 1. The system may also comprise an air valve 7 on the back end of the feed tube 4 to control the flow of compressed air into the feed tube 4 from airline 8 from a source of compressed air.

The base cavitation machine 1 may include any suitable components, depending on the application. For example, the base cavitation machine may include two hydraulic pumps that are utilized to push the paste through a very small orifice, into a very small vacuum chamber, and out another very small orifice that creates a specific desired back pressure. In one implementation, this combination of small orifices with a vacuum chamber in the middle is where the hydrodynamic cavitation occurs. In some implementations, the cavitation machine may include other components configured to introduce raw material through the very small orifice. For example, the cavitation machine may include components configured to inject or push the raw material through the very small orifice without the use of hydraulic pumps or pistons.

The embodiment of machine 1 depicted in FIG. 1 includes a hydraulic reservoir 13 and a motor 14 driving a pump 17. Pump 17 pumps the hydraulic oil up to an intensifier 15, which drives the oscillating plunger 11 that pushes the material up into the cavitation chamber 9, while the ball check system 12 closes to allow the material to be forced into the cavitation chamber 9, where the orifices are housed and the cavitation takes place. As the intensifier 15 pushes the plunger 11 forward, hydraulic oil in the front of the intensifier 15 is pushed against a nitrogen bag 16. After the plunger 11 in a fully actuated position, a positioning sensor stops the hydraulic pump 17 from driving the intensifier 15, and the pressure accumulates against the nitrogen bag 16, causing the plunger 11 to be pushed back to its starting position.

Depending on the application, the setups, including the number of feed tubes, may be varied. In one implementation, a small single feed tube containing the raw material may be employed for small batches that may be tested after each pass through the cavitation machine. The cavitation machine 1 also can include a first heating element 20 configured to apply heat to the feed tube 4 and a second heating element 22 configured to apply heat to the cavitation chamber 9. In some implementations, the cavitation machine 1 may include only the first heating element 20. In other implementations, the cavitation machine 1 may include only the second heating element 22. In other implementations, the cavitation machine 1 may include both the first heating element 20 and the second heating element 22. In some implementations, the first heating element 20 and the second heating element 22 can be resistive heaters or heating wrap positioned on the feed tube 4 and the cavitation chamber 9, respectively. The heating elements 20 and 22 can control the temperature of the raw material 5 inside the cavitation machine 1 to be in the range of about zero degrees Celsius to about 700 degrees Celsius. In some implementations, the heating elements can control the temperature of the raw material 5 to be in the range of about 50 degrees Celsius to about 100 degrees Celsius above the glass transition temperature of the raw material 5. The temperature can be below a thermal degradation temperature of the product material. The thermal degradation temperature can be a function of the material properties of the constituents of the material.

In other implementations, other types of heating elements may be used. For example, focused radiant energy (e.g., microwave, infrared, radio wave, etc.) can be used to implement the first heating element 20 and the second heating element 22. In other implementations, the heating elements 20 and 22 can be formed from immersion type systems, in which the portions to be heated are enclosed in a chamber such as a furnace to prepare a “water jacket.” The chamber can contain a solid, liquid or gas which conforms to the shape of the sections of the cavitation machine 1 to be heated. In some implementations, using a secondary material can facilitate more precise temperature control, because the temperature can remain substantially constant during a phase transition, such as melting or boiling. In some implementations, the chamber can also have a “Russian doll” configuration where an outer chamber such as a furnace encloses a smaller chamber, which contains the solid, liquid or gas medium surrounding the heated section of the cavitation system. Common gasses used in such a system can include, air, nitrogen, noble gases, steam, etc. Common liquids can include water, solvents with relatively high boiling points, or molten materials such as plastic or metal. In some implementations, solid materials such as thermally conductive powders can be used to conform to the shape of the cavitation machine 1 without melting. In still other implementations, the chamber can be heated using gas and/or electric heating elements. The heat can be transmitted from the furnace to the surrounding solid, liquid or gas via convection, conduction and/or radiation. Likewise, the heat will be transmitted to the cavitation machine via these mechanisms.

In some implementations, additional heating elements may be used. For example, it may be desirable to heat additional sections of the cavitation machine other than the sections that are shown in contact with the heating elements 20 and 22. Such additional heating elements also can be implemented using any of the techniques discussed above, including conventional heating jackets, printed thick film resistive heaters, or other heating techniques that make use of conduction, convection, and/or radiation.

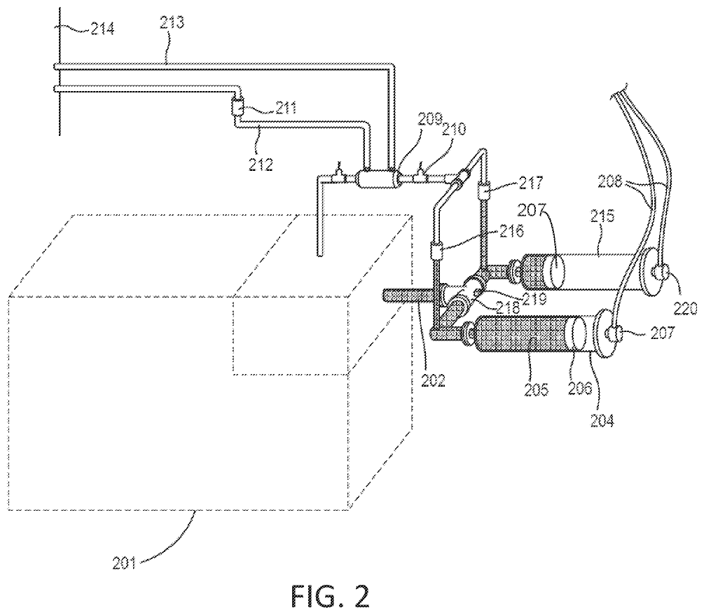

Referring now to FIG. 2, a schematic of another embodiment of a cavitation or emulsifying machine 201 is shown. As shown in FIG. 2, machine 201 includes a thermal control system and is a closed system that facilitates multiple cavitation passes. The thermal control system may comprise a heat exchanger 209 inline directly after the material 205 exits the cavitation process. The heat exchanger 209 may be followed (downstream) by a thermal couple 210, which is configured to read the temperature of the material after the material has passed the heat exchanger 209. Chilled water may be applied to the heat exchanger using a water valve 211 that allows water to flow from a chilled water source 214, via water tubing 212, through the heat exchanger 209, then out of the heat exchanger 209 and back to the return water connection of the chilled water via water tubing 213. Although not shown in FIG. 2, the thermal control system also can include heating elements positioned in contact with the tubes 204 and 215 (similar to the heating element 20 shown in FIG. 1), as well as a heating element positioned in contact with the cavitation chamber.

The flow of the water may be controlled manually or automatically, such as by a software program. In one implementation, a predetermined temperature may be inputted into a software program that, when executed, causes at least one processor to execute the thermal control system. In another implementation, the feedback from the thermal couple 210 may enable the software to adjust the water valve 211 such that the temperature of the material 205 exiting the thermal control system is within a desired range. In some implementations, the system can include additional thermal couples to measure the temperature of the material in the system at other areas. For example, additional thermal couples can be configured to measure temperatures of the material 205 going into the three-way valve 218, the temperature of the material 205 exiting the cavitation chamber, and the temperature of the material 205 exiting the heat exchanger 209. Outputs from all of these thermal couples may be used to control the flow of chilled water or the application of heat using heating elements such as the heating elements 20 and 22 shown in FIG. 1. In one implementation, the material 205 is processed in a single discrete pass. The tubes are then interchanged and the process may be repeated for as many passes as needed to achieve the desired product material properties.

The embodiment depicted by FIG. 2 is a closed system that allows and/or facilitates multiple cavitation passes. The closed system, which is further downstream from the thermal control system, may further comprise a second feed tube; a plurality of two-way valves and three-way valves configured to resupply the substance back into the hydrodynamic cavitation chamber to repeat the hydrodynamic cavitation process; and two pressure transducers. This implementation may be suitable for a larger-scale production than the smaller (e.g., R&D) implementation described above. One benefit of the closed system described herein is mitigation (such as complete elimination) of exposure to contamination (e.g., air).

The closed system depicted in FIG. 2 comprises two-way valves 216 and 217, which control the direction of the material 205 when it is being pushed into the system, as well as the direction the material 205 travels after it exits the heat exchanger 209. The system may further comprise a three-way valve 218, which is desirably in sync with the two-way valves 216 and 217 in order for the material to travel into the cavitation machine 201. In one implementation, when the material 205 in tube 204 is forced down the tube by the air driven piston 206, the two-way valve 216 must be closed so that the material travels past that valve and to the three-way valve 218. When the material is in tube 204, the three-way valve 218 allows the material to travel from tube 204 into the cavitation machine 201.

After cavitation takes place, the material 205 travels through the thermal control system and out of the heat exchanger 209, and past the thermal couple 210. At this point, the material then travels through the open two-way valve 217 and then into tube 215, pushing the air-driven piston 207 down the tube towards the back of the tube where the air valve 220 supplies air to the piston in tube 215. During this process of moving the material from tube 204 to tube 215, the air valve 220 is open so that air is able to be pushed out of tube 215 as it fills with material and the piston 207 is forced towards the back of tube 215. When tube 204 is empty, the piston 206 inside hits the front of tube 204, and there is no more pressure forcing the material 205 into the machine. In some implementations, the pressure within the system can be controlled to within a range of about 200 PSI to about 45,000 PSI, depending on the properties of the raw material 205 being processed.

A pressure transducer 219, which is located near the inlet of the machine 201 by the three-way valve 218, may transmit this drop in pressure to a software program, which then causes at least one processor to switch the two-way valves and three-way valves so that the material will travel from tube 215 back through cavitation machine 201 and back into tube 204. Once the valves have switched (217 closed, 216 open, and 218 switched) so that material travels from tube 215 into cavitation machine 201, the air valve 220 may automatically turn on and force the piston 207 and the material down tube 215 through the entire process and back to tube 204.

An operator or user may choose the number of times the material will pass through the cavitation machine 201, thereby repeating the cavitation and/or cooling processes (by the thermal control system). In one implementation, after a pre-determined number of passes, the system, as well as the air driving the valves and pistons, may automatically shut off. This safety feature may release the air pressure once the current cycle is completed. In one implementation, the system setups described herein allow samples of the material to be taken at any time to determine if the desired results have been achieved after a certain number of passes at the desired operating pressure(s) and temperature(s).

In one implementation, the systems described herein may use software and one or more thermal couples to control the temperature of the material. The thermal couples may be used to determine the temperature of the material 205 at one or more points in the process and those determined temperatures can be used to control a water valve, which controls the heating elements as well as the flow of chilled water to the heat exchanger. In one implementation, the material 205 is cooled after cavitation to reduce the temperature to a range that is suitable for the material being processed so that it remains stable and ready for the next cycle or pass. In some implementations, the thermal control system can control the heating elements and the water valve such that a thermal degradation temperature of the material is not exceeded. As discussed above, the machine 201 may be used to process various materials that can be used in additive manufacturing processes, such as pastes, powders, and filaments. In some implementations, when the machine 201 is used to process a paste, the temperature of the raw material can be maintained in the range of about 10 degrees Celsius to about 50 degrees Celsius. For processing thermoplastics in the absence of solvent, the temperature of the raw material in the machine 201 can be controlled to be about 25 degrees Celsius to about 100 degrees Celsius above the glass transition temperature of the polymer in the raw material. In some implementations, higher temperatures may be necessary for raw materials having a greater molecular weight or raw materials including branched polymers. Thus, in some implementations, the temperature of the raw material in the machine 201 can be controlled to be within a range of about zero degrees Celsius to about 700 degrees Celsius, depending on various properties of the raw material.

Without the temperature control system shown in FIG. 2, the material 205 may retain too much heat and may gain even more heat energy though each pass, resulting in damage to some of its constituents. When the material is processed with set parameters for pressure and temperature, which may be determined for each material through trial and error and/or parametric studies, the consistency of the product from lot to lot is surprisingly far superior to any other pre-existing process for preparing medium to high-viscosity inks, pastes, slurries or dispersions of nano-particles. The ability to move medium to high-viscosity materials in a continuous and controlled manner through the cavitation process by the systems and methods described herein is unexpected over the pre-existing methods.

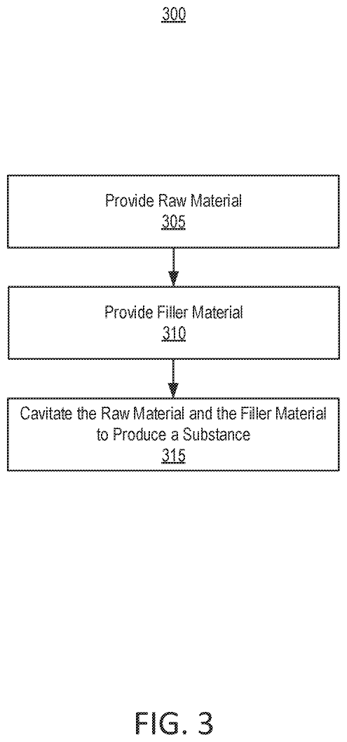

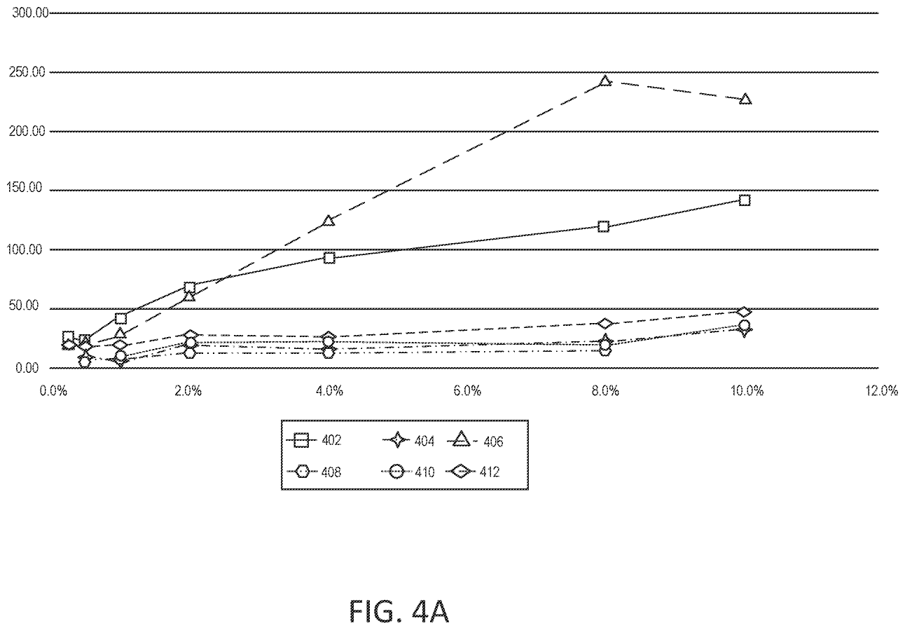

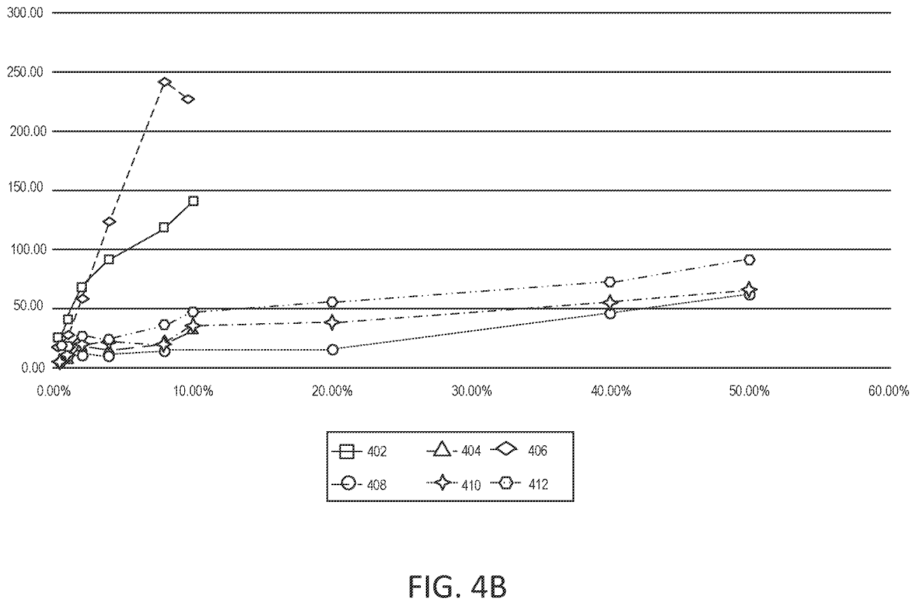

Now referring to FIG. 3 and in brief overview, shown is a schematic flowchart illustrating in some implementations a cavitation process 300 for manufacturing a substance having improved tensile strength (e.g., as discussed with reference to FIGS. 4-9) using any of the implementations of the cavitation machine described in FIGS. 1 and 2. As shown in FIG. 3, provided is raw material (305). A filler material can be provided (310). A formulation having the raw material and the filler material can be cavitated to produce a substance having improved tensile strength (315).

Still referring to FIG. 3 and in further detail, a raw material can be provided (305). For example, the raw material can be provided into a hydrodynamic cavitation chamber (e.g., cavitation machine 1). Examples of raw materials include polymers, inks, pastes, or filaments.

In some implementations, the raw material can include one or more sintering aids. A sintering aid can be any material positioned in between the particles of the raw material to enhance diffusion. In some implementations, a sintering aid can be selected to promote liquid phase sintering. Such techniques may be particularly useful for use in raw materials having ceramics that are difficult to sinter. In some other implementations, a sintering inhibitor can be added to the raw material. For example, a sintering inhibitor can include any material that tends to prevent diffusion and contact between particles of other materials in the raw material.

In some implementations, the raw material can include particles of a fugitive material. Fugitive materials can be materials that will break down during the sintering process, thereby resulting in gaps in the microstructure of the finished three-dimensional object. In some implementations, fugitive materials can be selected to achieve a desired degree of porosity in the finished object. In some implementations, fugitive materials can include carbon-based compounds that will break down through pyrolysis, hydrogenation, oxidation, gasification, vaporization or any combination of these processes. Polymers also may be used as fugitive materials. For example, fugitive materials such as polyethylene (PE), polysaccharides (rice starches, celluoses, gums, etc.), acrylics (PMMA, PBMA, etc.), vinyls (PVB, PVA, PVAc), polycarbonates, PVP, polyamides, polyimides, may be included in the raw material. Particulate systems including carbon black, graphite, graphene, and nanotubes, can combined with these polymers to form these cavities or channels within the structure of the finished object.

In some implementations, the raw material can include one or more solvents. For example, solvents may include acetic acid, acetone, acetonitrile, benzene, butanol, butyl acetate, carbon tetrachloride, chlorobenzene, chloroform, cyclohexane, 1,2-dichloroethane diethyl ether, diethylene glycol, diglyme (diethylene glycol dimethyl ether), 1,2-dimethoxy-ethane (glyme, DME), dimethylether dimethyl-formamide (DMF), dimethyl sulfoxide (DMSO), dioxane, ethanol, ethyl acetate, ethylene glycol, gamma butyrl lactone (GBL), glycerin, heptane, hexamethylphosphoramide (HMPA), hexamethylphosphorous triamide (HMPT), hexane, methanol, methyl t-butyl ether (MTBE), methylene chloride, N-methyl-2-pyrrolidinone (NMP), nitromethane, pentane, Petroleum ether, propanol, propylene carbonate, pyridine, terpineol, tetrahydrofuran (THF), texanol, toluene, triethyl amine, water, and xylene.

In some implementations, the raw material also can include one or more surfactants. For example, surfactants can include anionic types (e.g., carboxylates, phosphate esters, sulfonates, petroleum sulfonates, alkylbenzenesulfonates, naphthalenesulfonates, olefin sulphonates, alkyl sulfates, sulfates, sulfated natural oils & fats, sulfated esters, sulfated alkanolamides, alkylphenols, ethoxylated and sulfated, etc.), nonionic types (e.g., ethoxylated aliphatic alcohol, polyoxyethylene surfactants, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, etc.), cationic type (e.g., quaternary ammonium salts, amines with amide linkages, polyoxyethylene alkyl & alicyclic amines, n,n,n′,n′ tetrakis substituted ethylenediamines, 2-alkyl 1-hydroxethyl 2-imidazolines, etc.), and amphoteric type (e.g., n-coco 3-aminopropionic acid/sodium salt, n-tallow 3-iminodipropionate, disodium salt, n-carboxymethyl n dimethyl n-9 octadecenyl ammonium hydroxide, n-cocoamidethyl n hydroxyethylglycine, sodium salt, etc.).

The filler material can be provided (310). The filler material can be provided with the raw material. The filler material can be provided into a hydrodynamic cavitation chamber (e.g., cavitation machine 1). The raw material may have the functional filler material added to it to increase the tensile strength or functionality of the resultant substance.

In some implementations, the raw material also may include fillers, metals, alloys, and polymers, in addition to ceramic particles. Non-limiting examples of materials that may be included in the raw material include aluminum magnesium boride, aluminum oxynitride, barium strontium cobalt ferrite, barium titanate, beryllium oxide, bismuth strontium calcium copper oxide, bone china, boron nitride, briquetage, calcium aluminates, cenosphere, ceramic colorants, ceramic flux, ceramic foam, ceramic matrix composite, cerium hexaboride, coade stone, crittersol, dysprosium titanate, earthenware, electroceramics, hubnerite (e.g., manganese tungsten oxide), expanded clay aggregate, ferroelectric ceramics, fire clay, frit, fumed silica, geopolymer, geopolymer concrete, germanium dioxide, glass-ceramic, grog (clay), hafnium diboride, hydroxyapatite, jesmonite, kaolin/kaolinite, lanthanum gallium silicate, lanthanum hexaboride, lanthanum strontium cobalt ferrite, lanthanum strontium manganite, lead scandium tantalate, lead zirconate titanate, lumicera, magnesium diboride, magnesium oxide, martensite, nile silt, max phases, metal clay, molybdenum disilicide, mud, porcelain, paper clay, quartz, sea pottery, sialon, silica fume, silicon boride, silicon carbide, silicon dioxide, silicon nitride, silicon oxynitride, soapstone, strontium titanate, tetragonal polycrystalline zirconia, titanium carbide, tube-based nanostructures, tungsten disilicide, tungsten nitride, ultra-high-temperature ceramics, vitreous china, yttrium barium copper oxide, zinc oxide, zirconia toughened alumina, zirconium dioxide, AlN, Si3N4, SiC, WC, Al203, Zr02 (Y, Mg, etc. stabilized), MgO, Si02, glasses, ZnO, Ti02, PbO, PbTi03, PbZr03, BaTi03, BiTi03, SrTi03, MgTi03, CaTi03, solid solutions of ceramics, CeO (Gd, Sm, etc. stabilized), Y203, BeO, ceramic colorants, bismuth strontium calcium copper oxide, titanium chromium, manganese, iron, cobalt, nickel, copper, zinc, molybdenum, ruthenium, rhodium, palladium, silver, tantalum, tungsten, rhenium, osmium, iridium, platinum, gold, aluminum, gallium, indium, tin, lead, bismuth, germanium, arsenic, antimony, and astatine.

In some implementations, the ceramic particles may be in powder form. Ceramic powders can be combined with other materials to form the substance having improved tensile strength. For example, ceramic powder can be coated with liquids, which may improve the green strength of the raw material through surface tension. In some other implementations, ceramic powders can be coated with polymers to form the raw material. Polymer-coated powder can also improve green strength of the raw material, because the polymer may serve as a tether between particles of the raw material. In some implementations, the raw material can include ceramic particles having a first average size, which may be mixed with particles of another material having a smaller average size than the average size of the ceramic particles, in order to fill the interstices between the ceramic particles. In some implementations, particle size of the raw material can be selected to increase, or maximize, the green bulk density of the raw material.

The formulation having the raw material and the filler material can be cavitated to produce a substance having improved tensile strength (315). The formulation can be loaded into an engineered cavitation feed tube, which is attached to the cavitation machine (e.g., cavitation machine 1). In some implementations, the formulation is forced into the hydrodynamic cavitation chamber by an air-driven piston, air, hydraulics, or a mechanical force. A piston in the feed tube is then driven down the feed tube (pneumatically in this example) to push or force the formulation into the cavitation machine.

A cavitation process can be applied within the hydrodynamic cavitation chamber to the formulation to make the substance having improved tensile strength. The cavitation process can de-agglomerate the formulation without changing its morphology. For example, if the formulation includes core-shell particles, the cavitation process can de-agglomerate the formulation without damaging the shells and/or exposing the cores of the core-shell particles. In another example, the cavitation process can homogenously disperse solid fillers in the suspension of the formulation. By de-agglomerating the formulation without changing its morphology, the cavitation process can enable the manufacture of the substance having improved tensile strength as described herein.

The cavitation process can be applied to the whole formulation of the materials described herein. For example, the cavitation process can be applied to a formulation that includes the raw materials and filler material described herein. Applying the cavitation process to the whole formulation can be efficient (e.g., use less time or power) and result in an improved substance having improved tensile strength.

The cavitation process can disperse the functional filler material into the raw material. The cavitation process can reduces the agglomeration of functional filler particles in the resultant substance. In particular, the cavitation process can disrupt the aggregate, and can also replace random particle-particle contact and/or air trapped at the solid/vapor, liquid/vapor interface with particle-solvent, particle-polymer, particle-oligomers, contact, etc. Additional cavitation processes can be used to mix components such as a multi component resin system or a multiple particulate system. The particles can be differing chemical composition or simply different sizes/morphologies to tailor particle packing to engineer structures with controlled densities for a particular structure function relationship. For example, the cavitation process can mix two particle sizes together at 70 coarse/30 fine (usually 1/10 ratio) to fill interstitial space of large particle with the fines to increase density. The cavitation process can also minimize density.

In addition to reducing particle aggregates into uniformly distributed particles (of the primary particle size), the energetic conditions of the cavitation process can be used to facilitate more intimate mixing of components. For instance, the cavitation process can disperse the components in the mixture to facilitate the intimate mixing. In particular, the cavitation process can mix fillers and matrix components. For example, the surface of particulate materials can be coated with oligomers, solvents, polymer and other precursors of a matrix by overcoming activation energies required and/or accelerating the kinetic rates of these processes. Another example is to force materials to stick to surfaces that may be energetically unfavorable under standard temperature and pressures, however the rate of relaxation/separation may be sufficiently slow to offer a metastable system. For instance, higher surface area material can have a natural tendency to aggregate to minimize the surface free energy. The process may be able to replace in situ a coating on a particulate filler with the polymer/oligomer of choice. The process can also serve as a catalyst to drive kinetics without adding impurities to the raw material.

The processes described above may be used to form metastable dispersions of liquid fillers. Beyond dissolution and emulsions, liquid fillers can be physically entrapped within polymers having a high molecular weight to form metastable mixtures, such as core shell systems. Core-shell systems can control density. Core-shell polymer may be attached to the surface of a dense filler to slow Stokes settling. The core-shell particles can be between 35% and 95% of the weight and 30% to 64% of the volume of the formulation. For example, the formulation can include a mixture of core-shell particles and silver particles. The formulation can include nanoparticles to fill interstitial spaces within the formulation. The nanoparticles can be core-shell particles or silver particles. Core-shell systems also allow for physical/phase separation of reactive components, which may be useful to stabilize two-part mixtures that rely on breakage of the emulsion/core-shell structure to cure. Core-shell structures may also be used to form reaction vessels for partitioning chemical reactions that are to occur simultaneously.

In some implementations, the cavitation processes described above may be used to disperse polymers within other polymers; that is, to drive irreversible entanglement of “insoluble polymers” or even disperse oligomers within a polymer to control Tg, crystallinity, density, or elongation.

In some implementations, the cavitation process can disperse high volumetric loadings of particles within a suspension. These dispersions can be intermediates or ingredients in formulated products. In some implementations, the cavitation process can alter the morphology of the particles, such as exfoliating layers without fracturing high aspect ratio flakes. By effectively dispersing the high surface area materials in a suspension, the cavitation process described herein can increase the viscosity of the material beyond the capabilities of conventional high shear mixers, media mills and even high-pressure homogenizers. Since formulators may not be able to prepare such highly loaded suspensions of high surface area materials, the dispersions can be added to other components in the mixture such that the resulting mixture has a lower viscosity.

In some implementations, the materials can be separately added to the formulation of cavitated materials. For example, the raw material can be pushed down a feed tube into the cavitation machine. The cavitation process can be applied to the raw material such that the raw material is passed through the cavitation machine and returned to the feed tube via a feedback tube. The filler material can be pushed down the feed tube into the cavitation machine. The cavitation process can be applied to both the raw material, which underwent a pass within the cavitation machine, and the added filler material. The first and second material can undergo one or more passes in the cavitation machine. For example, the cavitation process can be applied to the formulation such that it undergoes 1, 2, 3, 4, or 5 passes in the cavitation machine before additional materials are added. The cavitation process can be applied to the formulation until it has a predetermined chemical or physical characteristic. For example, the cavitation process can be applied to the formulation until its viscosity is lower than a predetermined threshold, or it is de-agglomerated. Additional materials can be added to the formulation. More than one material can be added at any given time. For example, cavitation process can be applied to a formulation that includes the raw and filler material, a third and fourth material can be added, and then the cavitation process can be applied to a formulation of the third material, the fourth material, and the cavitated formulation of the cavitated raw material and the cavitated filler material.

In some implementations, the materials can be separately forced into the cavitation machine for cavitation as a formulation. For example, the raw material can be pushed down a first feed tube into the cavitation machine, and the filler material can be pushed down a second feed tube into the cavitation machine. Additional materials can be added via additional feed tubes. The cavitation process can be applied to all the materials as they are separately forced into the cavitation machine. Additional materials can be added at any time, such as after the previous materials undergo a predetermined amount of passes within the cavitation machine.

The formulation can be forced into the cavitation machine to undergo the cavitation dispersion process. The driving-through-piston or a heat blanket can heat the formulation. The formulation can go through the cavitation dispersion process and the temperature thereof increases due at least in part to thermal energy generated by high pressures. In some implementations, the cavitation machine can heat the formulation to a temperature between 25° C. and 100° C. In some implementations, the temperature can be between 20° C. and 100° C., between 25° C. and 80° C., between 30° C. and 60° C., between 35° C. and 50° C., between 40° C. and 50° C., etc. Other values are also possible, depending on the application. In some implementations, the cavitation machine can pressurize the formulation to a pressure between 0 and 45,000 psi. In some implementations, the pressure can be between 100 psi and 100,000 psi, between 500 psi and 80,000 psi, between 1,000 psi and 50,000 psi, between 2.000 psi and 10,000 psi, between 3,000 psi and 5,000 psi, etc. Other values are also possible, depending on the application.

The formulation then go into a heat exchanger after exiting the cavitation dispersion process to cool to a predetermined temperature (or temperature range), during which a thermocouple measures the temperatures downstream and/or upstream from the heat exchanger. A software program can receive feedback from the thermocouple located downstream from the heat exchanger and actuates a water valve that controls the flow of chilled water to the heat exchanger. When the improved paste exits the heat exchanger, it is at the desired predetermined temperature at least as a result of the thermal control.

The cavitation dispersion process can be applied to the formulation multiple times. For example, the formulation can undergo multiple passes (e.g., 2, 3, 4, or 5) in the cavitation machine. The cavitation process can be applied to the formulation until it reaches a predetermined chemical or physical characteristic. For example, the cavitation process can be applied to the formulation until its viscosity is lower than a predetermined threshold, or it is de-agglomerated.

In some implementations, the cavitation machine described herein applies the cavitation process multiple times to the formulation. As the formulation is pushed down a feed tube, it passes a closed two-way valve and travels through an open three-way valve, past a pressure transducer and thermocouple and into the cavitation machine. After the formulation is forced into the cavitation machine, the formulation passes through the cavitation dispersion process. After the cavitated formulation (e.g., substance having improved tensile strength) flows out of the heat exchanger, it passes through the open two-way valve connecting to feed tube and into feed tube, pushing the piston in feed tube towards the back of the tube. When feed tube is empty and the formulation has completed one pass, the piston that forces the formulation then hits the front of the feed tube and stops; at this time the pressure of the formulation going through the three-way valve drops. A pressure transducer mounted to the three-way valve reads the pressure drop as a result of the feed tube being empty—when the software receives this feedback, it switches the two-way valves, three-way valve, and product air valves that control the air pushing the piston in the feed tube. After the software switches the valves and air supply, the formulation begins to feed back into the cavitation machine from feed tube, past a closed two-way valve and through the three-way valve to return into the machine. The software allows a user to enter the number of passes and set the temperature; after this information has been entered into the software, the machine can run the set number of passes automatically at a consistent temperature.

Depending at least on the equipment involved, the manufacturing of the substance having an improved tensile strength for solar material can include a number of additional steps. For example, the substance can be cooled using a thermal control, including, for example, at least a feedback temperature control. In another example, the formulation can be pressurized by using at least an air-driven piston, hydraulics, or a mechanical force. In another example, forcing the formulation into the cavitation chamber (through the small orifice) can generate a lot of heat. The elevated temperature as a result of the addition of this heat can be controlled subsequently through the thermal control as described above.

In some implementations, the substance undergoes curing. In some implementations, directed sources of energy can be applied to the selected areas of the layer of substance to promote fusion of the particles of the substance. In some implementations, the focused energy can be rastered across the layer of substance in a pattern corresponding to a desired shape of the three-dimensional object. Energy can be applied to the layer of substance, for example, using a stylus, a beam, or a heated platen.

In some implementations, sintering can be accomplished by applying localized heat or localized pressure to the areas of the layer of substance that are intended to be sintered. For example, both heat and pressure can be applied using one or more heated platens. In some implementations, the heated platen can be patterned or shaped according to the desired shape of the object being formed. Thus, the platen can be pressed directly onto the layer of substance, and the shape of the heated platen can serve as a mask in areas where sintering is not desired, while facilitating transfer of heat and pressure where sintering is desired. The temperature of the platen and the pressure exerted by the platen on the layer of substance can be selected to achieve a desired degree of sintering of the substance.

In some implementations, light energy can be used to selectively fuse the particles of substance. For example, the substance can include at least one photosensitive material, and light energy can be used to cure the photosensitive material in areas where particle fusion is desired. In some implementations, the light energy can be infrared (IR) radiation. IR radiation can be applied directly to the surface of the layer of substance by an emitter. The substance can absorb at least some of the IR radiation, and the temperature of the substance can increase as a result. The increased temperature can cause fusion of the particles of substance. In some implementations, the wavelength of the IR radiation can be selected based on thickness of the layer of substance. For example, shorter wavelength IR radiation may be able to penetrate into a thicker layer of substance than longer wavelength IR radiation.

In some implementations, microwave heating can be used to selectively fuse particles of the substance. For example, microwave heating can rapidly increase the temperature of the substance. The heat can be generated internally within the layer of substance and then be transmitted outwards towards the surfaces of the substance, thereby resulting in an inverse heating profile. The rapid heating rate that can be achieved with microwave heating can minimize the impurity phases that can be produced at low temperatures, which typically inhibit sintering.

In some implementations, an external electric field or magnetic field can be used to selectively fuse particles of the substance. Electric fields or electric current can be applied using an electron beam or an electrified stylus that is pressed against the surface of the layer of substance. For example, the stylus can be an electrified wheel or a mounted sphere configured to roll across a surface of the layer of substance. Other forms of sintering also may be used to form the first layer of the object. For example, spark plasma sintering (SPS) or laser shock peening (LSP) can be used to fuse particles of the substance. As discussed above, liquid phase sintering also can be used to fuse particles of the substance in implementations in which the substance includes a liquid phase sintering aid.

Reliability tests can be performed to assess the tensile strength of the resulting substance. The improved tensile strength and other improved aspects of the present technology is further illustrated in Examples 1-7, FIGS. 4A-8C, and Tables 1-5; which should not be construed as limiting in any way. Examples 1-7, FIGS. 4A-8C, and Tables 1-5 demonstrate the preparation, characterization, and use of the cavitation process described herein.

The test conditions included dispersing a variety of high aspect-ratio fillers (single and multi-wall carbon nanotubes and boron nitride) into Trilene 65 material, manufactured by Lion Elastomers of Pot Neches, Texas. The fillers were cleaved with the previously-described cavitation process to form high surface area ‘2D’ sheets. Solvent was added to reduce viscosity of the liquid master batches produced. In some implementations, test conditions between 80 and 200 degrees Celsius may allow dispersion in Trilene 65 without solvent addition. Test coupons can be made by filling molds and heating in box ovens to drive off the solvent from the master batch and cure the material. In particular, the test conditions included a 120-Celsius dry for 1.5 hours, a 150-Celsius pre-cure for 10 minutes, and a 175-Celsius cure for 1 hour. Akrochem DDPH peroxide and TAIC co-agent were used as curatives. Tensile strength of the cured material can be measured. For example, the test can include measuring pull force/strength (N or kg) on test coupons by adding weight until specimens broke. Due to solvent loss, specimen thickness varied and thickness can be measured to calculate the normalized force. The measured fillers include single wall carbon nanotubes (SWCNT), multi-walled carbon nanotubes (MWCNT), purified SWCNT, Boron Nitride (PT-132), Boron Nitride (BTBN5006), and Boron Nitride (BTBN5003).

### Example 1

Referring now to FIGS. 4A and 4B, FIG. 4A depicts a graph of experimental data corresponding to a first range of high aspect ratio filler proportions relative to tensile strength of Trilene 65, and FIG. 4B depicts a graph of experimental data corresponding to a second range of high aspect ratio filler proportions relative to tensile strength of Trilene 65. FIGS. 4A and 4B include measurements 402 illustrating normalized pull force measurements (Newtons) based on various proportions of single wall carbon nanotubes (SWCNT) Nn, measurements 404 illustrating normalized pull force measurements (Newtons) based on various proportions of multi-walled carbon nanotubes (MWCNT), measurements 406 illustrating normalized pull force measurements (Newtons) based on various proportions of purified SWCNT, measurements 408 illustrating normalized pull force measurements (Newtons) based on various proportions of Boron Nitride (PT-132), measurements 410 illustrating normalized pull force measurements (Newtons) based on various proportions of Boron Nitride (BTBN5006), and measurements 412 illustrating normalized pull force measurements (Newtons) based on various proportions of Boron Nitride (BTBN5003). The x-axis is weight for weight (w/w) corresponding to the proportion of the filler within the Trilene 65 material, and the y-axis is normalized pull force (Newtons).

As shown in FIG. 4A and FIG. 4B, the SWCNT have the largest increase in pull force of all fillers tested. However, using Boron Nitride (BN) may be advantageous in some applications because of its insulative electrical nature, excellent thermal conductivity, and the higher loadings that can be achieved without significantly increasing viscosity. In some implementations, dispersing the SWCNT into lower-viscosity Trilene ethylene-propylene copolymer grades can allow for the production of solvent-free master batch products that could be used in two-roll milling processes.

### Example 2

Table 1 depicts experimental data corresponding to various proportions of SWCNT relative to tensile strength of Trilene 65 in the form of pull force (Newtons), normalized pull force (Newtons), and durometer (A scale).

TABLE 1
increasing the proportion of the SWNCT
in the Trilene 65 increases the pull force
and the durometer of the resulting material

| CNT to T65 | pull force, N | normalized, N | durometer, A |
|---|---|---|---|
| 0.25% | 27.00 | 19.24 | 73 |
| 0.50% | 33.25 | 20.87 | 76 |
| 1.00% | 44.50 | 28.75 | 76 |
| 2.00% | 43.50 | 59.92 | 84 |
| 4.00% | 102.50 | 124.54 | 85 |
| 8.00% | 109.00 | 241.15 | 92 |
| 10.00% | 86.00 | 227.51 | 92 |

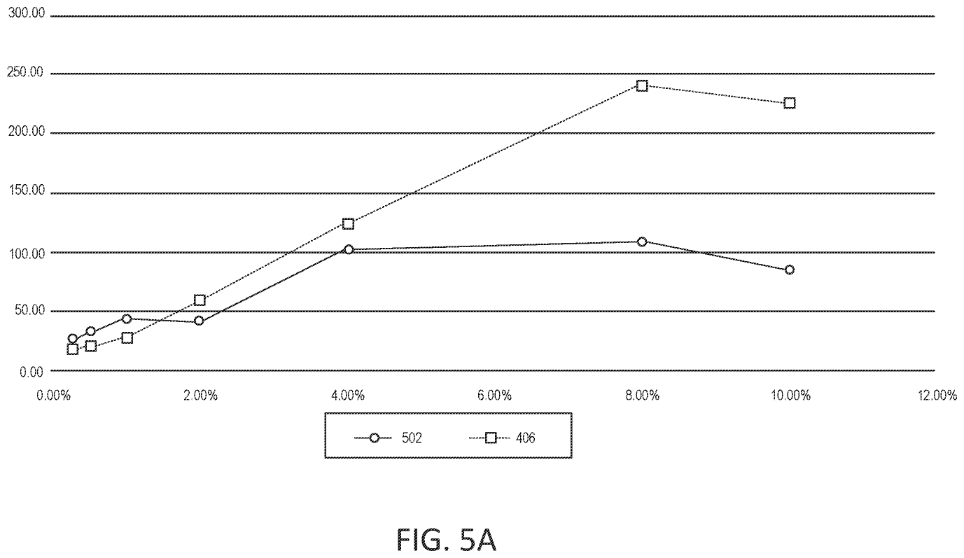

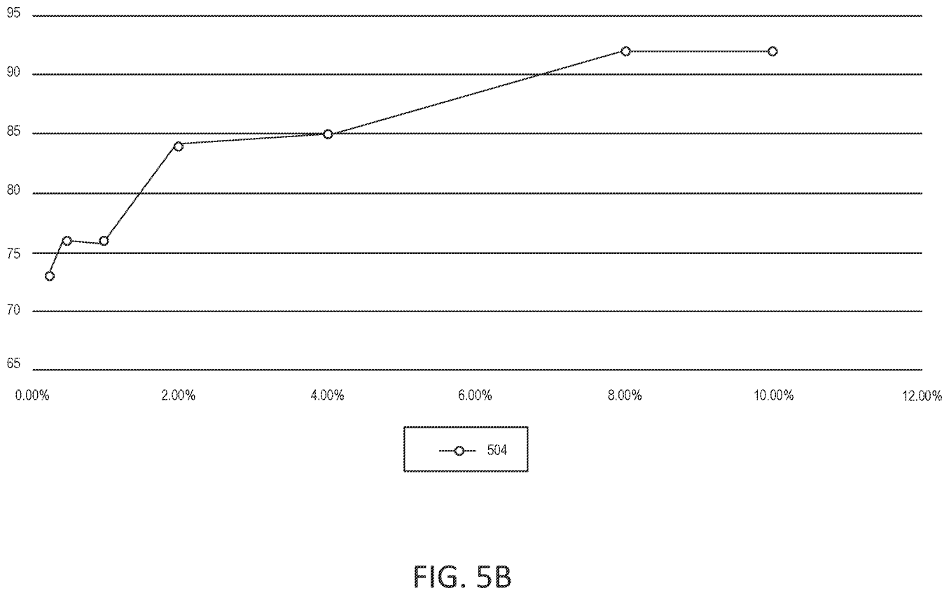

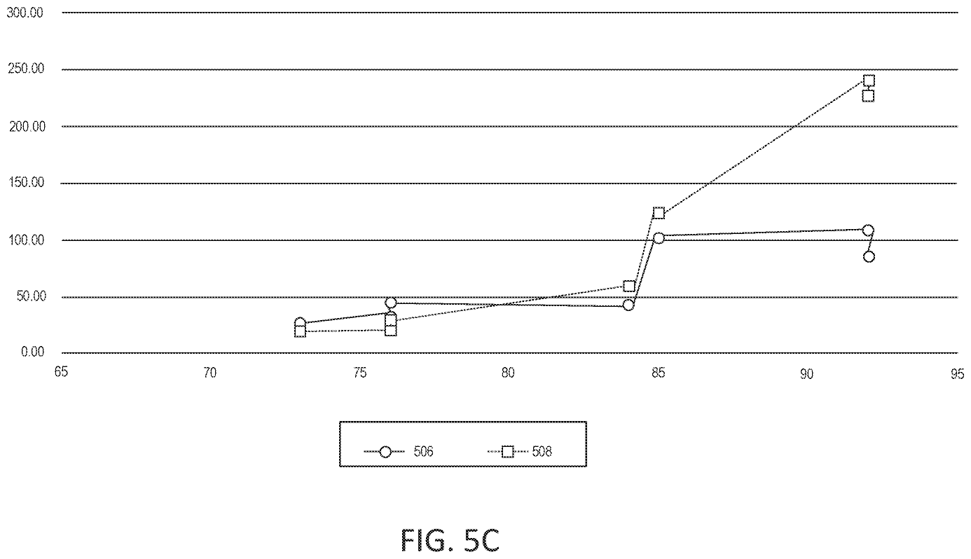

Referring now to FIGS. 5A-5C, FIGS. 5A-5C depict the experimental data of Table 1. In particular, FIG. 5A includes measurements 406 and measurements 502 illustrating the tensile strength of Trilene 65 (pull force in Newtons) based on various proportions of SWCNT. The x-axis is weight for weight (w/w) corresponding to the proportion of the SWCNT within the Trilene 65 material, and the y-axis is pull force (Newtons). FIG. 5B depicts measurements 504 illustrating the durometer (A scale) of Trilene 65 based on various proportions of SWCNT. The x-axis is weight for weight (w/w) corresponding to the proportion of the filler within the Trilene 65 material, and the y-axis is pull force (Newtons). FIG. 5C depicts measurements 506 illustrating the durometer (A scale) and pull force (Newtons) of Trilene 65 mixed with various proportions of SWCNT, and measurements 508 illustrating the durometer (A scale) and normalized pull force (Newtons) of Trilene 65 mixed with various proportions of SWCNT. The x-axis is durometer (A Scale), and the y-axis is pull force (Newtons).

As shown in FIGS. 5A-5C, increasing the proportion of the SWNCT in the Trilene 65 increases the pull force and the durometer of the resulting material.

Decreasing the CNT to T65 w/w % can enable light to pass through the resulting formulation effectively while still increasing tensile strength. In some implementations, the CNT to T65 w/w % can be 0.01%-0.25%, such as 0.1%, or 0.2%. In some applications, even a very small fraction of a percent can cause an increase in tensile strength, while allowing the light energy needed to cure the material pass through the formulation effectively.

### Example 3

Table 2 depicts experimental data corresponding to various proportions of Boron Nitride (PT-132) relative to tensile strength of Trilene 65 in the form of pull force (Newtons), normalized pull force (Newtons), and durometer (A scale).

TABLE 2
increasing the proportion of the Boron
Nitride (PT-132) in the Trilene 65 increases the
pull force and the durometer of the resulting material

| BN to T65 | pull force, N | normalized force, N | durometer, A |
|---|---|---|---|
| 0.50% | 7.70 | 5.44 | 68 |
| 1.00% | 12.40 | 9.23 | 66 |
| 2.00% | 17.60 | 13.11 | 78 |
| 4.00% | 20.70 | 13.18 | 77 |
| 8.00% | 20.20 | 15.82 | 80 |
| 20.00% | 25.10 | 16.59 | 79 |
| 40.01% | 50.10 | 47.40 | 82 |
| 50.00% | 98.85 | 63.32 | 84 |
| 75.00% | 45.00 | 46.97 | 89 |

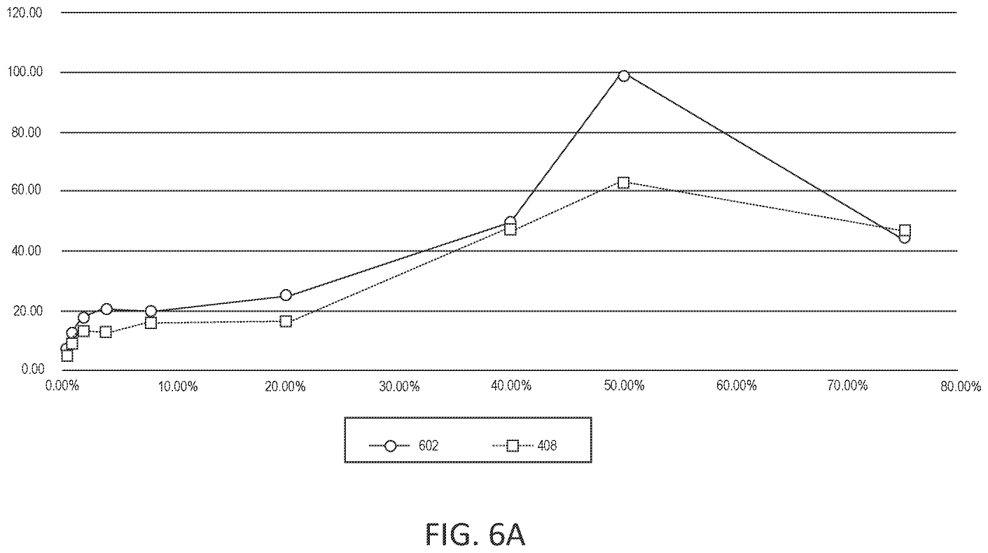

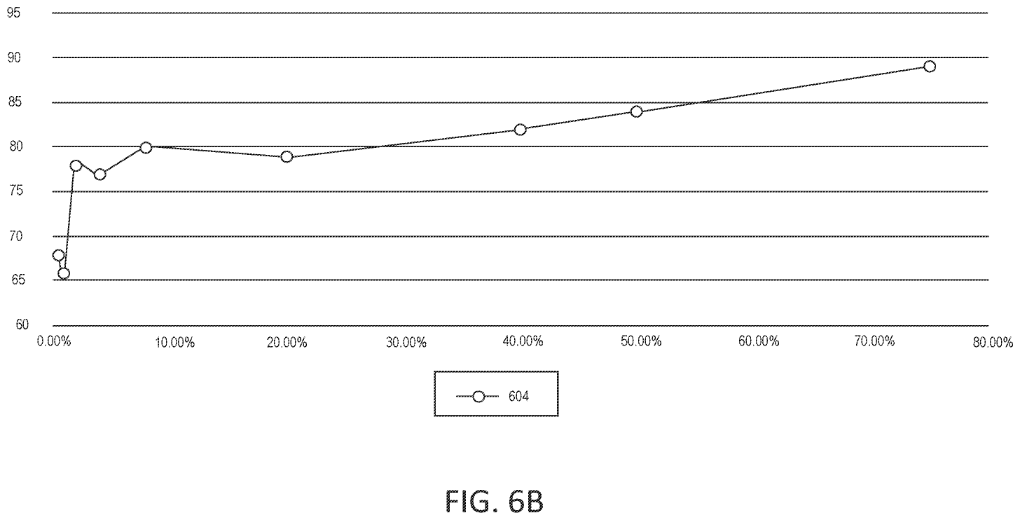

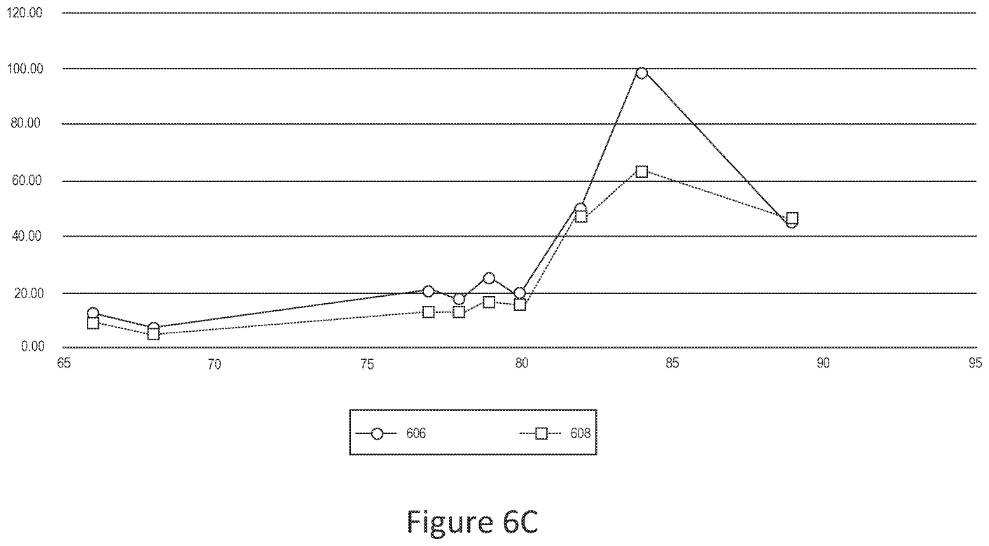

Referring now to FIGS. 6A-6C, FIGS. 6A-6C depict the experimental data of Table 2. In particular, FIG. 6A depicts measurements 408 and measurements 602 illustrating tensile strength of Trilene 65 (pull force in Newtons) based on various proportions of Boron Nitride (PT-132). The x-axis is weight for weight (w/w) corresponding to the proportion of the Boron Nitride (PT-132) within the Trilene 65 material, and the y-axis is pull force (Newtons). FIG. 6B depicts measurements 604 illustrating the durometer (A scale) of Trilene 65 based on various proportions of Boron Nitride (PT-132). The x-axis is weight for weight (w/w) corresponding to the proportion of the Boron Nitride (PT-132) within the Trilene 65 material, and the y-axis is pull force (Newtons). FIG. 6C depicts measurements 606 illustrating the durometer (A scale) and pull force (Newtons) of Trilene 65 mixed with various proportions of Boron Nitride (PT-132), and measurements 608 illustrating the durometer (A scale) and normalized pull force (Newtons) of Trilene 65 mixed with various proportions of Boron Nitride (PT-132). The x-axis is durometer (A Scale), and the y-axis is pull force (Newtons).

As shown in FIGS. 6A-6C, increasing the proportion of the Boron Nitride (PT-132) in the Trilene 65 increases the pull force and the durometer of the resulting material.

Decreasing the Boron Nitride to T65 w/w % can enable light to pass through the resulting formulation effectively while still increasing tensile strength. In some implementations, the BN to T65 w/w % can be 0.01%-0.5%, such as 0.1%, 0.2%, 0.3%, or 0.4%. In some applications, even a very small fraction of a percent can cause an increase in tensile strength, while allowing the light energy needed to cure the material pass through the formulation effectively.

### Example 4

Table 3 depicts experimental data corresponding to various proportions of Boron Nitride (BTBN5006) relative to tensile strength of Trilene 65 in the form of pull force (Newtons), normalized pull force (Newtons), and durometer (A scale).

TABLE 3
increasing the proportion of the Boron Nitride
(BTBN5006) in the Trilene 65 increases the
pull force and the durometer of the resulting material

| BN to T65 | pull force, N | normalized force, N | durometer, A |
|---|---|---|---|
| 1.00% | 15.00 | 10.48 | 73 |
| 2.00% | 21.50 | 21.87 | 69 |
| 4.00% | 24.00 | 22.86 | 77 |
| 8.00% | 28.00 | 20.74 | 78 |
| 10.00% | 34.50 | 35.90 | 81 |
| 20.00% | 54.50 | 39.49 | 86 |
| 40.00% | 73.50 | 57.20 | 91 |
| 50.00% | 78.50 | 66.92 | 85 |
| 75.00% | 58.00 | 57.60 | 93 |

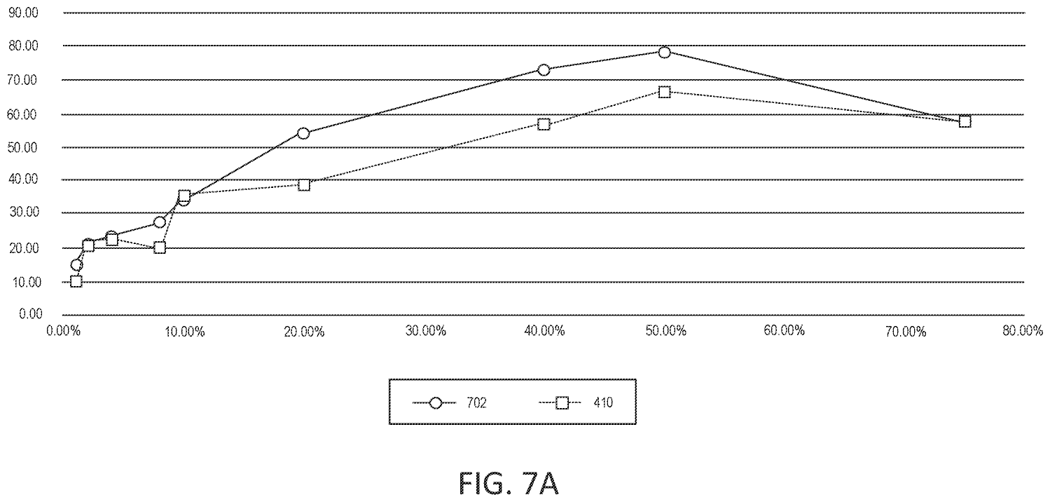

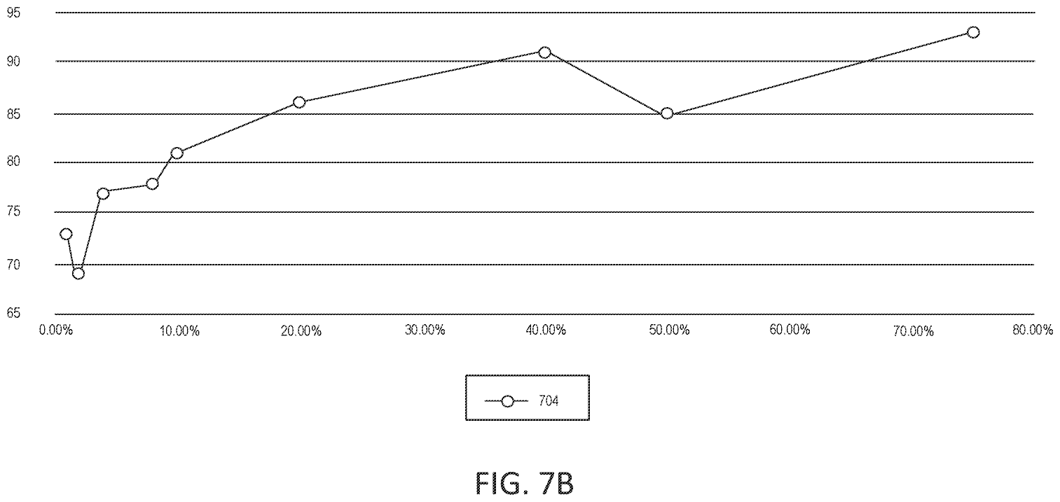

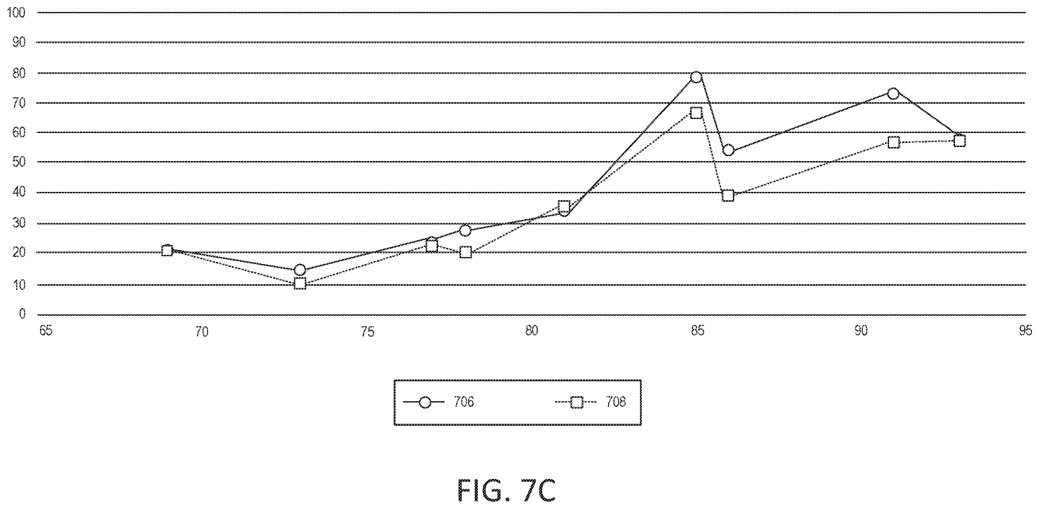

Referring now to FIGS. 7A-7C, FIGS. 7A-7C depict the experimental data of Table 3. In particular, FIG. 7A includes measurements 410 and measurements 702 illustrating the tensile strength of Trilene 65 (pull force in Newtons) based on various proportions of Boron Nitride (BTBN5006). The x-axis is weight for weight (w/w) corresponding to the proportion of the Boron Nitride (BTBN5006) within the Trilene 65 material, and the y-axis is pull force (Newtons). FIG. 7B depicts measurements 704 illustrating the durometer (A scale) of Trilene 65 based on various proportions of Boron Nitride (BTBN5006). The x-axis is weight for weight (w/w) corresponding to the proportion of the filler within the Trilene 65 material, and the y-axis is pull force (Newtons). FIG. 7C depicts measurements 706 illustrating the durometer (A scale) and pull force (Newtons) of Trilene 65 mixed with various proportions of Boron Nitride (BTBN5006), and measurements 708 illustrating the durometer (A scale) and normalized pull force (Newtons) of Trilene 65 mixed with various proportions of Boron Nitride (BTBN5006). The x-axis is durometer (A Scale), and the y-axis is pull force (Newtons).

As shown in FIGS. 7A-7C, increasing the proportion of the Boron Nitride (BTBN5006) in the Trilene 65 increases the pull force and the durometer of the resulting material.

### Example 5

Table 4 depicts experimental data corresponding to various proportions of Boron Nitride (BTBN5003) relative to tensile strength of Trilene 65 in the form of pull force (Newtons), normalized pull force (Newtons), and durometer (A scale).

TABLE 3
increasing the proportion of the Boron Nitride
(BTBN5003) in the Trilene 65 increases the
pull force and the durometer of the resulting material

| BN to T65 | pull force, N | normalized N | durometer, A |
|---|---|---|---|
| 0.50% | 27.0 | 19.57 | 62 |
| 1.00% | 18.5 | 19.68 | 60 |
| 2.00% | 29.0 | 27.51 | 62 |
| 4.00% | 33.0 | 26.23 | 66 |
| 8.00% | 45.0 | 37.82 | 65 |
| 10.00% | 39.5 | 48.00 | 70 |
| 20.00% | 52.0 | 56.89 | 75 |
| 40.00% | 91.0 | 73.68 | 87 |
| 50.00% | 132.0 | 92.83 | 91 |
| 75.00% | 70.5 | 53.86 | 94 |

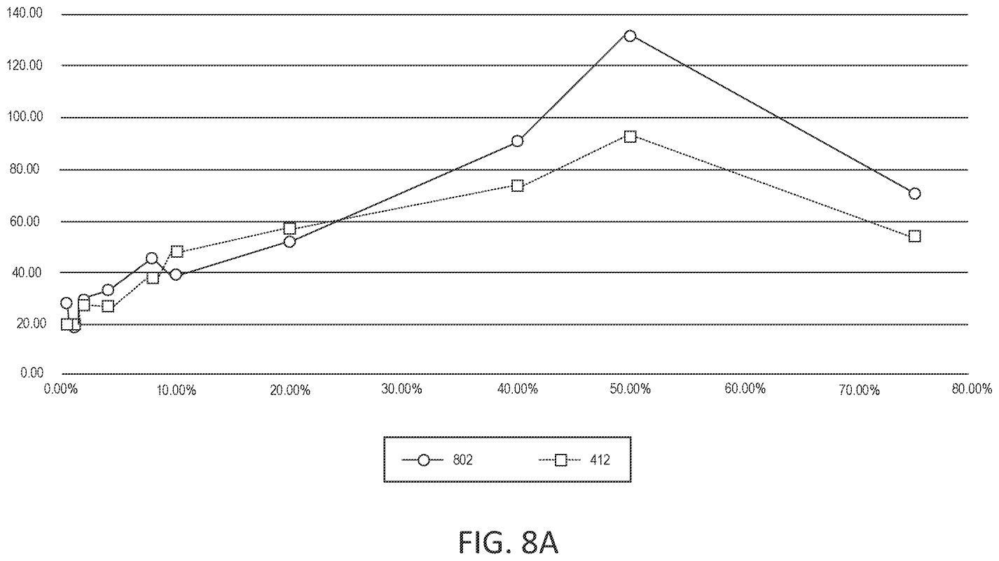

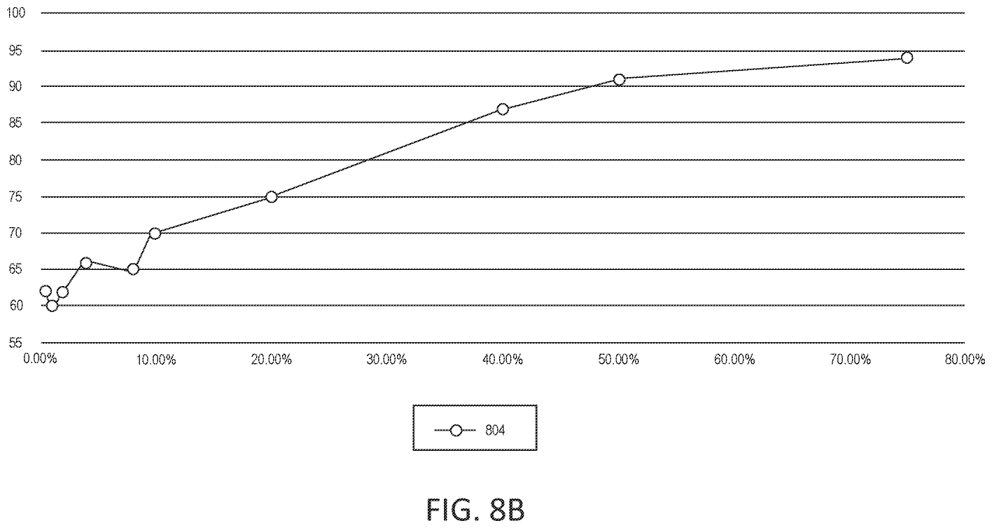

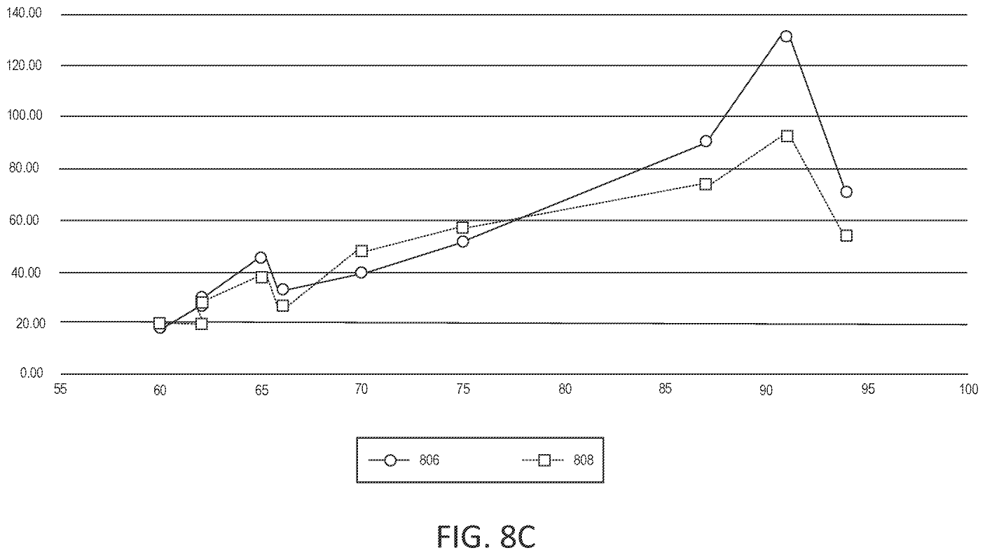

Referring now to FIGS. 8A-8C, FIGS. 8A-8C depict the experimental data of Table 4. In particular, FIG. 8A depicts measurements 412 and measurements 802 illustrating tensile strength of Trilene 65 (pull force in Newtons) based on various proportions of Boron Nitride (BTBN5003). The x-axis is weight for weight (w/w) corresponding to the proportion of the Boron Nitride (BTBN5003) within the Trilene 65 material, and the y-axis is pull force (Newtons). FIG. 8B depicts measurements 804 illustrating the durometer (A scale) of Trilene 65 based on various proportions of Boron Nitride (BTBN5003). The x-axis is weight for weight (w/w) corresponding to the proportion of the Boron Nitride (BTBN5003) within the Trilene 65 material, and the y-axis is pull force (Newtons). FIG. 8C depicts measurements 806 illustrating the durometer (A scale) and pull force (Newtons) of Trilene 65 mixed with various proportions of Boron Nitride (BTBN5003), and measurements 808 illustrating the durometer (A scale) and normalized pull force (Newtons) of Trilene 65 mixed with various proportions of Boron Nitride (BTBN5003). The x-axis is durometer (A Scale), and the y-axis is pull force (Newtons).

As shown in FIGS. 8A-8C, increasing the proportion of the Boron Nitride (BTBN5003) in the Trilene 65 increases the pull force and the durometer of the resulting material.

### Example 6

In some implementations, Halloysite or other layered structures such as Cloisite, Laponite, hubnerite (e.g., manganese tungsten oxide), and other clays and nano-clays can be another filler for increasing strength using the cavitation process described herein. Halloysite is an aluminosilicate clay that can spontaneously form multilayer tubular morphologies in the submicron range from rolled platelets. Halloysite can have high surface area layers display different charges, and the gap between the layers can be controlled by the cavitation process described herein. Cloisite is a nanoclay that may include a high surface area and high aspect ratio. Laponite is a synthetic smectite clay, which may include disk-shaped nanoscale crystals. The silica and alumina surfaces can further be differentially grafted through surface treatments, (such as surfactants) to facilitate interaction with hydrophobic materials. Through use of hydrodynamic cavitation, the materials can be effectively dispersed, the layers can be exfoliated, and the local temperature and pressures can be applied to facilitate effective surface modification of the materials.

### Example 7

Table 5 depicts experimental data corresponding to liquid photopolymers used in 3D printing and other applications. The fillers were nano-cellulose fibers and Boron Nitride. Samples include a base and 4 samples comprising one of the two aforementioned filler materials as well as non-filled control samples. In particular, 4 samples were blade coated onto release Mylar & cured in a UV oven for two passes with each pass lasting 8 minutes. The blade coat thickness was 0.005″ (0.127 mm) for the samples. The test can include using a photoinitiator of Rahn Genocure ITX (isopropylthioxanthone) at a 1.00% w/w proportion. Table 5 depicts experimental data corresponding to liquid photopolymers. In particular, Table 5 depicts the formulations, the pull strengths, and strength normalized to the same thickness.

TABLE 5
Experimental data corresponding to liquid photopolymers. 1057-10 base, 1057-10A2, 1057-10B2, and 1057-10B3 all had good though cure
and no tack. 1057-10B4 had fair through cure and mild tack. Both additives can increase the strength of the base photopolymer.

| | | | | | | | | | thickness | thickness |
|---|---|---|---|---|---|---|---|---|---|---|
| | | | | | | | | | A | B |
| | | | | | | | | | normalization thickness, in. | |
| | | | | | | | pull | | 0.005 | 0.0025 |
| | Genomer | Genocure | Genomer | Genomer | cellulose | | strength, | | norm. A, | norm. B, |
| sample | 4316 | ITX | 1122TF | 1117 | fibers | BTBN5003 | N | thickness, in | N | N |
| 1057- | 98.00% | 2.00% | | | | | 6.55 | 0.00985 | 3.32 | 1.66 |
| 10 base | | | | | | | | | | |
| 1057- | 48.27% | 0.99% | 48.72% | | 2.03% | | 12.53 | 0.00710 | 8.82 | 4.41 |
| 10A2 | | | | | | | | | | |
| 1057- | 36.46% | 0.74% | | 36.49% | | 26.31% | 9.05 | 0.00230 | 19.67 | 9.84 |
| 10B2 | | | | | | | | | | |
| 1057- | 58.07% | 1.19% | | 23.68% | | 17.07% | 10.31 | 0.00330 | 15.62 | 7.81 |
| 10B3 | | | | | | | | | | |
| 1057- | 78.01% | 1.59% | | 11.85% | | 8.55% | 6.77 | 0.00735 | 4.61 | 2.30 |
| 10B4 | | | | | | | | | | |

Photopolymers with fillers can have enhanced properties. For instance, the fillers can increase the tensile strength and impact strength of the resulting material compared to the base photopolymer. The fillers can also increase performance characteristics related to density, cross-linking density, transition temperatures, and light scattering. However, without uniform and homogeneous dispersion of the fillers, the resulting material may have suboptimal properties such as light scatter, improper cures, undetermined particle deposit locations, uncertain particle size, and thin layers. Accordingly, the implementations presented herein disperse the filler uniformly and homogeneously to prevent light scattering while improving characteristics, such as tensile strength, of the resulting material. The effective level of dispersion enabled by cavitation in this system allows for a higher filler loading without suboptimal properties, compared to any other method of dispersion, which increases the aforementioned beneficial properties. In particular, rather than merely immersing the filler, the high level activation energy of cavitation overcomes surfaces of the filler and causes physical entanglement and interaction of the polymers to disperse the filler throughout the base material.

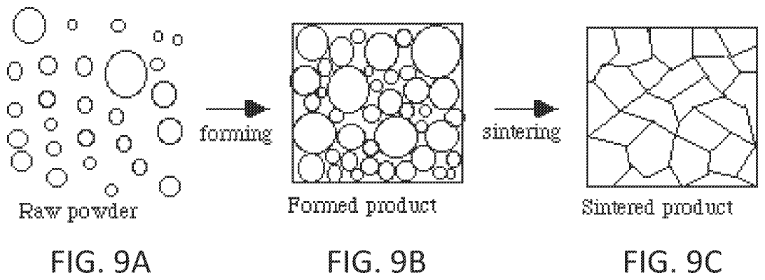

FIGS. 9A-9C illustrate the steps of forming a sintered product from a raw material, according to an illustrative implementation. In general, sintering can refer to a process for forming a solid mass from a raw material containing discrete particles, such as a powder, without melting the raw material. First, a raw powder can include loosely packed particles of raw material, as shown in FIG. 9A. The raw powder can be compacted, for example by applying vibration or external pressure to the raw material, to create a formed product, as shown in FIG. 9B. Finally, the formed product can be sintered, for example, by directing a focused source of energy at the particles of the formed product, as shown in FIG. 9C. Sintering can proceed from various mass-transport mechanisms, which can be divided into surface-transport mechanisms and bulk-transport mechanisms.

In surface-transport mechanisms, atoms of the raw material move from the surface of one particle to the surface of another particle. In bulk-transport mechanisms, atoms move from the particle interior to the surface. Surface-transport mechanisms can lead to neck growth without shrinkage or densification, while bulk-transport mechanisms can result in net particle movement, leading to shrinkage and densification (i.e., an increase in packing density of the particles). Surface-transport mechanisms can include surface diffusion and vapor transport. Bulk-transport mechanisms can include lattice diffusion, grain boundary diffusion, and viscous flow. In powders composed of different materials, chemical reactions may also provide additional mass-transport mechanisms. Such chemical reactions are sometimes referred to as reactive sintering.

Different mass-transport mechanisms can dominate at different points in the sintering process, and different raw materials can exhibit different mechanisms. For instance, a process called viscous flow is diffusion in the liquid phase, while a process called evaporation condensation, or vapor diffusion, can occur in the gaseous phase. Evaporation condensation and surface diffusion are referred to as non-densifying mechanisms, because they do not contribute significantly to pore shrinkage; these processes increase the cohesion of grains by the increase of the grain contacts. Other mass-transport mechanisms can contribute to the decrease of the volume fraction of pores (i.e., the shrinkage).

The raw material used for sintering can be referred to as compaction powder or green compact. Compaction powder can have a large surface area relative to its volume. This surface area can provide the driving force in sintering, which is the reduction of free surface energy resulting from the high surface area of the particles. The driving force of the sintering process is the reduction of overall free energy by the decrease of specific surface area and compact interfaces. Solid-state sintering may be performed by two alternative processes. First, solid-state sintering can be performed by reduction of the total surface area by an increase in the average size of the particles, which leads to coarsening. Second, solid-state sintering can be performed by the process of grain growth, which leads to densification. These two mechanisms can be in competition with one another. Therefore, if the atomic processes that lead to densification dominate, pores can become smaller and may disappear with time, however if the atomic processes that lead to coarsening are faster, both the pores and grains coarsen and may become larger with time.

In some implementations, the reliability tests can indicate whether the substance includes the raw material and filler material de-agglomerated without damage to the morphology of the raw material and the filler material in the formulation. Visual observation can be carried out by a naked eye, an optical microscope, or an electron microscope. For example, the improved paste can be assessed or analyzed using microscopy with compositional characterization devices. The analysis can be based on EDS/WDS, Auger, or Raman/FTIR. In some implementations, the metric used to describe the phenomenon of the substance maintaining intact core-shell structures can be the lack of changes in conductivity. In some implementations, the metric corresponds to solar cell efficiency. The core-shell structures can remain intact for an extended period of time.

In some implementations, the improved paste has a conductivity lower than a conductivity of the formulation before cavitation. In some implementations, a short circuit current and open circuit voltage of the substance can be acquired. In some implementations, the cavitation process can be reapplied to the substance until the short circuit current and the open circuit voltage each satisfy a respective predetermined threshold.

The viscosity of the improved paste can generally be lower after the cavitation dispersion process than the viscosity before the cavitation dispersion process due at least in part because of subjecting the formulation to the temperatures and the pressures. The viscosity varies with the material and also varies with the pressure and the temperature. For example, the viscosity after cavitation can be 10% to 90% of the viscosity before cavitation, 20% to 80%, 30% to 70%, 40% to 60%, 45% to 55%, etc., of the first viscosity. In some implementations, the second viscosity is 25% to 50% of the first viscosity.

The substance as a result of fabrication can be used in a variety of devices. For example, the product material can be disposed onto a substrate to form a pattern on the substrate. The pattern can be, for example, gridlines. The substrate can be a part of a device, such as any of the devices described herein.

As described above, any part of the method, when used in conjunction with the cavitation machines described herein, can be automated. The automation can be accomplished at least in part using a software program. In some implementations, the software program is stored on a non-transitory computer-readable medium. The program, when executed, causes at least one processor (such as a computer) to execute any of the methods (or portions thereof) described herein.

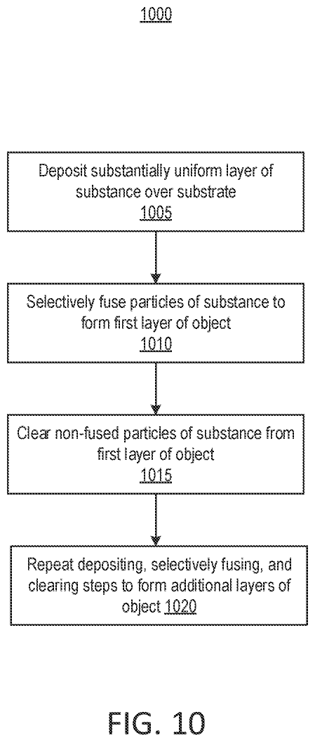

FIG. 10 provides a flowchart illustrating an example additive manufacturing process 1000, according to an illustrative implementation. In brief overview, the process 1000 includes depositing a substantially uniform layer of substance onto a substrate (stage 1005). Particles of the raw material can be selectively fused to form a first layer of an object (stage 1010). Non-fused particles of the substance can be cleared from the first layer of the object (stage 1015). The steps of depositing a substantially uniform layer of substance, selectively fusing particles of the substance, and clearing non-fused particles of substance can then be repeated to form additional layers of the object above the first layer (stage 1020).

Referring again to FIG. 10, and in greater detail, the process 1000 includes depositing a substantially uniform layer of substance onto a substrate (stage 1005). The layer of raw material can include ceramic particles having a substantially uniform particle size. As discussed above, the mass transport mechanisms associated with sintering processes can be more effective for particles having a uniform size. Therefore, in some implementations, sintering of the raw material may be accomplished more easily due to the uniform size distribution of particles of the raw material. In some implementations, the raw material can be produced by introducing materials into the cavitation apparatus described above in connection with FIGS. 1 and 2 in order to produce a substance having improved tensile strength and/or having substantially no agglomeration of particles. Thus, in some implementations, the size of the particles in the raw material can be approximately the same as the primary particle size, because agglomeration can be substantially eliminated.

In some implementations, after the substance is deposited onto the substrate, the deposited layer of substance can be compacted to increase the density of the deposited layer. In some implementations, vibration or pressure can be used to promote compaction of the deposited layer. For example, the deposited layer of substance can be subjected to external pulsed vibration or external pressure to increase its density and uniformity of thickness.

The process 1000 includes selectively fusing particles of the substance to form a first layer of the object (stage 1010). In some implementations, the particles can be selectively fused using a sintering process. As discussed above, sintering can be accomplished using a directed source of energy applied to the selected areas of the layer of substance to promote fusion of the particles of the substance. In some implementations, the focused energy can be rastered across the layer of substance in a pattern corresponding to a desired shape of the three-dimensional object. Energy can be applied to the layer of substance, for example, using a stylus, a beam, or a heated platen.

In some implementations, sintering can be accomplished by applying localized heat or localized pressure to the areas of the layer of substance that are intended to be sintered. For example, both heat and pressure can be applied using one or more heated platens. In some implementations, the heated platen can be patterned or shaped according to the desired shape of the object being formed. Thus, the platen can be pressed directly onto the layer of substance, and the shape of the heated platen can serve as a mask in areas where sintering is not desired, while facilitating transfer of heat and pressure where sintering is desired. The temperature of the platen and the pressure exerted by the platen on the layer of substance can be selected to achieve a desired degree of sintering of the substance.

In some implementations, light energy can be used to selectively fuse the particles of substance. For example, the substance can include at least one photosensitive material, and light energy can be used to cure the photosensitive material in areas where particle fusion is desired. In some implementations, the light energy can be infrared (IR) radiation. IR radiation can be applied directly to the surface of the layer of substance by an emitter. The substance can absorb at least some of the IR radiation, and the temperature of the substance can increase as a result. The increased temperature can cause fusion of the particles of substance. In some implementations, the wavelength of the IR radiation can be selected based on thickness of the layer of substance. For example, shorter wavelength IR radiation may be able to penetrate into a thicker layer of substance than longer wavelength IR radiation.

In some implementations, microwave heating can be used to selectively fuse particles of the substance. For example, microwave heating can rapidly increase the temperature of the substance. The heat can be generated internally within the layer of substance and then be transmitted outwards towards the surfaces of the substance, thereby resulting in an inverse heating profile. The rapid heating rate that can be achieved with microwave heating can minimize the impurity phases that can be produced at low temperatures, which typically inhibit sintering.

In some implementations, an external electric field or magnetic field can be used to selectively fuse particles of the substance. Electric fields or electric current can be applied using an electron beam or an electrified stylus that is pressed against the surface of the layer of substance. For example, the stylus can be an electrified wheel or a mounted sphere configured to roll across a surface of the layer of substance. Other forms of sintering also may be used to form the first layer of the object. For example, spark plasma sintering (SPS) or laser shock peening (LSP) can be used to fuse particles of the substance. As discussed above, liquid phase sintering also can be used to fuse particles of the substance in implementations in which the substance includes a liquid phase sintering aid.

The process 1000 includes clearing non-fused particles of the substance from the first layer of the object (stage 1015). In some implementations, any suitable means for removing non-fused particles can be used. For example, non-fused particles can be brushed off of the first layer of the object by a doctor blade or a squeegee. In some other implementations, jetted air or vibration can be used to remove non-fused particles from the first layer of the object.

The process 1000 also includes repeating the steps of depositing the substance, selectively fusing particles of the substance, and clearing non-fused particles of the substance to form additional layers of the object above the first layer (stage 1020). For example, a new layer of substance can be deposited over the first layer of the object. The new layer of substance also can have properties similar to the first layer of substance deposited in stage 1005. For example, the new layer of substance may include ceramic particles having a substantially uniform size. In some implementations, the new layer of substance may be different from the first layer of substance. For example, the new layer of substance may include different material to achieve different mechanical or electrical properties. Particles of the new layer of substance can be selectively fused using any of the techniques described above, and the non-fused particles can be cleared from the new layer of the object. These steps can be repeated any number of times, until the three-dimensional object is complete. While no post-processing may be required, in some implementations, the three-dimensional object can be post processed to promote additional sintering and densification of the object.

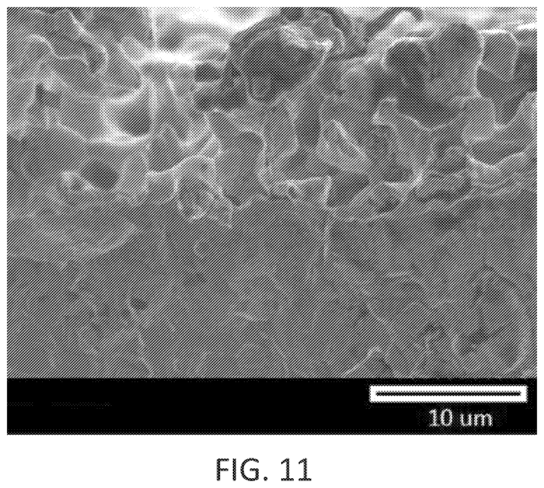

FIG. 11 provides a microscopy image of a cross section showing platinum co-fired on zirconia, according to an illustrative implementation. In some implementations, the sample shown in the cross section of FIG. 11 can be included within a catalytic sensor. The upper layer of the sample shown in FIG. 11 is formed from platinum, while the lower layer is formed from zirconia. In this example, the upper platinum layer was screen printed onto the lower zirconia layer, and the sample was heated in a furnace at about 1375 degrees Celsius to promote sintering. In some implementations, the platinum layer of the sample shown in FIG. 11 can be used as a conductive electrode layer or as part of a heater in a catalytic sensor, while the zirconia layer can serve as an insulating layer.

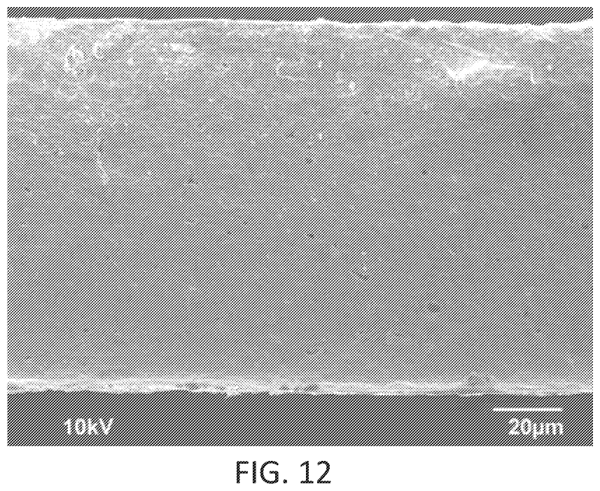

FIG. 12 provides a microscopy image of a cross section showing nano alumina, according to an illustrative implementation. Samples of nano alumina such as that shown in FIG. 12 can be useful in a variety of applications. For example, the additive manufacturing techniques described in this disclosure can be used to form devices having one or more layers of nano alumina, including seal rings, medical prostheses, laser tubes, electronic substrates, ballistic armour, thermocouple tubes, electrical insulators, grinding media, threadguides, and wear components.

Applications

The methods and systems described herein may be employed in a variety of applications. For example, systems and methods may be used to form multilayer electronic devices using the additive manufacturing techniques described above. In some embodiment, a process similar to the process 300 shown in FIG. 3 or the process 1000 shown in FIG. 10 can be used to build such a device by selectively fusing conductive and insulating substances, rather than be fusing patterned layers of the raw materials. In some implementations, systems and methods may use filler material as a mechanical reinforcement fill in composites or a Nano container for the delivery of active agents in at least anticorrosion, antimicrobial, drug delivery, crosslinking, and pesticide release in specialty formulated products. In some implementations, the cavitation process can create a master batch, which is filled with a polymer or other similar material to a high solids loading utilizing the cavitation process described herein to disperse the filler. The resulting dispersed concentrated product can be an additive in other products.

Devices fabricated according to these techniques can be useful in Scaffolds for tissue engineering, time released drugs, prosthetics, dental devices, firearms/projectiles, sensors, communication devices, microprocessors, engines/turbines, structural elements for automobiles and spacecraft, foods/pastries, children's toys, clothing, musical instruments, drones, etc.

### ADDITIONAL NOTES

While the present teachings have been described in conjunction with various implementations and examples, it is not intended that the present teachings be limited to such implementations or examples. On the contrary, the present teachings encompass various alternatives, modifications, and equivalents, as will be appreciated by those of skill in the art.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described implementations of the invention may be implemented in any of numerous ways. For example, some implementations may be implemented using hardware, software or a combination thereof. When any aspect of an implementation is implemented at least in part in software, the software code may be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various implementations of the technology discussed above. The computer readable medium or media may be transportable, such that the program or programs stored thereon may be loaded onto one or more different computers or other processors to implement various aspects of the present technology as discussed above.

Also, the technology described herein may be embodied as a method, of which at least one example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially” and “about” used throughout this Specification are used to describe and account for small fluctuations. For example, they may refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. A method of manufacturing a substance having an improved tensile strength for additive manufacturing, the method comprising:
providing raw material having a first tensile strength;
providing a filler material; and
cavitating, within a hydrodynamic cavitation chamber, the raw material and the filler material to produce a substance having a second tensile strength greater than the first tensile strength.

2. The method of claim 1, further comprising:
heating the raw material and the filler material to a temperature between 80° C. and 200° C.

3. The method of claim 1, further comprising:
applying ultraviolet (UV) light energy to the substance to cure the substance.

4. The method of claim 1 further comprising:
forcing, the raw material and the filler material into an orifice of the hydrodynamic cavitation chamber.

5. The method of claim 1, wherein providing the filler material comprises providing a clay comprising Halloysite, Cloisite, Laponite, or Hubnerite.

6. The method of claim 1, wherein providing the filler material comprises providing a single wall carbon nanotube that comprises 0.25 to 10.00% weight for weight (w/w) of the raw material.

7. The method of claim 1, wherein providing the filler material comprises providing a multi-walled carbon nanotube that comprises 0.25 to 10.00% w/w of the raw material.

8. The method of claim 1, wherein providing the filler material comprises providing a purified single wall carbon nanotube that comprises 0.25 to 10.00% w/w of the raw material.

9. The method of claim 1, wherein providing the raw material comprises providing the raw material comprising an ethylene-propylene copolymer.

10. The method of claim 1, wherein providing the raw material comprises providing the raw material comprising a solvent.

11. The method of claim 10, further comprising applying heat to the substance to remove the solvent.

12. A substance useful in additive manufacturing produced by the method of claim 1.

13. A substance useful in additive manufacturing having an improved tensile strength, the substance comprising:
a raw material including a polymer, the raw material having a first tensile strength; and
a clay entangled in the raw material to produce the substance having a second tensile strength greater than the first tensile strength.

14. The substance of claim 13, wherein the raw material is an ethylene-propylene copolymer.

15. The substance of claim 13, wherein the clay comprises Halloysite, Cloisite, Laponite, or Hubnerite.

16. A substance that is useful in additive manufacturing having an improved tensile strength, the substance comprising:
a raw material including a polymer, the raw material having a first tensile strength; and
a carbon material entangled in the raw material to produce the substance having a second tensile strength greater than the first tensile strength.

17. The substance of claim 16, wherein the carbon material is a single wall carbon nanotube that comprises 0.01 to 10.00% w/w of the raw material.

18. The substance of claim 16, wherein the carbon material is a multi-walled carbon nanotube that comprises 0.01 to 10.00% w/w of the raw material.

19. A substance that is useful in additive manufacturing having an improved tensile strength, the substance comprising:
a raw material including a polymer, the raw material having a first tensile strength; and
Boron Nitride entangled in the raw material to produce the substance having a second tensile strength greater than the first tensile strength.

20. The substance of claim 19, wherein the Boron Nitride comprises 0.01 to 75.00% w/w of the raw material.
